(19) United States
(12) Patent Application Publication
(10) Pub. No.: US 2026/0079128 A1
(43) Pub. Date: Mar. 19, 2026

(54) STRUCTURAL ANALYSIS OF IONISED MOLECULES

(71) Applicant: Thermo Fisher Scientific (Bremen) GmbH, Bremen (DE)

(72) Inventors: Alexander A. MAKAROV, Bremen (DE); Anatoly VERENCHIKOV, St. Petersburg (RU)

(73) Assignee: Thermo Fisher Scientific (Bremen) GmbH, Bremen (DE)

(21) Appl. No.: 19/334,225

(22) Filed: Sep. 19, 2025

Related U.S. Application Data
(63) Continuation of application No. 17/254,257, now abandoned.

(30) Foreign Application Priority Data
Jun. 22, 2018 (GB) 1810273.1

(51) Int. Cl. G01N 27/622; G01N 27/624; G01N 27/626; H01J 49/00; H01J 49/02; H01J 49/16

(52) U.S. Cl. CPC G01N 27/622; G01N 27/624; G01N 27/628; H01J 49/0031; H01J 49/0045; H01J 49/025; H01J 49/164

(57) ABSTRACT

An ion mobility spectrometry method is described comprising: providing a sample; generating molecular ions from the sample; separating the molecular ions according to their mobility characteristics; fragmenting at least some of the separated molecular ions to form sub-molecular fragment ions in a fragmentation zone; separating at least some of the fragment ions according to their mobility characteristics; wherein the separation and fragmentation steps are performed at a pressure of at least 50 mbar; detecting at least some of the separated fragment ions; and identifying at least one molecular ion based on its mobility characteristics and/or the mobility characteristics of at least one detected fragment ion.

### CROSS REFERENCE TO RELATED APPLICATIONS

This application is a continuation of U.S. application Ser. No. 17/254,257, filed Dec. 18, 2020, which is a national stage entry under 35 U.S.C. § 371 of International Patent Application PCT/EP2019/064943, filed Jun. 7, 2019, which claims benefit of priority to United Kingdom Patent Application No. 1810273.1, filed Jun. 22, 2018, all of the above applications being incorporated herein by reference.

### FIELD

The invention relates to structural analysis of ionised molecules, in particular utilising ion mobility spectrometry and/or mass spectrometry.

### BACKGROUND

The techniques of ion mobility spectrometry (IMS) and mass spectrometry (MS) enable the structural analysis of ionised molecules.

Known ion mobility spectrometers typically comprise an apparatus in which ions are caused to drift through a drift space under the influence of a constant or time-varying (e.g. oscillating) electric field and/or a flowing gas and separate in time and/or space before the separated ions are detected. The separated ions may be further processed, for example subjected to fragmentation and/or further ion separation, before being detected.

Various constructions of ion mobility spectrometers have been proposed. One type of IMS apparatus comprises a buffer gas-filled drift tube or cell, wherein ion pulses separate in an axial DC potential created by a series of ring electrodes axially spaced apart along the length of the spectrometer, for example as disclosed in U.S. Pat. Nos. 5,162,649, 6,992,284 and 6,479,815. The ions reach the exit of the drift tube at different times dependent on their ion mobility. Another type of IMS apparatus comprises a drift tube wherein a travelling DC wave is applied to select ions of certain mobility, for example as disclosed in U.S. Pat. No. 5,789,745. The buffer gas is often arranged flowing in the opposite direction to the direction of ion travel.

While such types of IMS may use pulses of ions, other types of IMS use continuous ion beams. A type of IMS known as field-asymmetric ion mobility spectrometry (FAIMS) is known, wherein a continuous beam of ions, rather than pulses of ions, separates in an asymmetric oscillating electric field on the basis of an ion mobility non-linearity with respect to the electric field, for example as disclosed in U.S. Pat. Nos. 5,420,424, 6,690,004, WO00/08454.

An IMS apparatus known as a differential mobility analyzer (DMA) also employs a continuous beam of ions, which are separated in space in a crossed (i.e. transverse) DC electric field and gas flow, for example as disclosed in U.S. Pat. Nos. 5,869,831 and 6,787,763. Resolving power up to 110 has been achieved by DMA (e.g. M. Amo-Gonzalez and S Perez, Planar Differential Mobility Analyzer (DMA) with Resolving Power of 110, Analytical Chemistry 2018). Another type of IMS is Transverse Modulation IMS in which a continuous beam of ions is filtered to allow passage of only those ions that return strictly on an axis after passing through a combination of axial DC field and perpendicular RF field, for example as disclosed in U.S. Pat. No. 8,378,297, US2016/0133451.Still another type of IMS is trapped ion mobility spectrometry (TIMS). Rather than driving ions through a stationary gas, as in a drift tube, TIMS holds the ions stationary in a moving column of gas (as described in Mark E. Ridgeway, Markus Lubeck, Jan Jordens, Mattias Mann, Melvin A. Park, Trapped ion mobility spectrometry: A short review, International Journal of Mass Spectrometry 425 (2018) 22-35).

An ion mobility spectrometer may be operated on its own as a means for ion separation, or it may be used in combination with other ion separation devices in so-called hybrid IMS instruments. Examples of hybrid IMS instruments include those based on liquid chromatography IMS (LC-IMS) or gas chromatography IMS (GC-IMS).

Many ion mobility spectrometers are operable at atmospheric pressure, as disclosed for example in U.S. Pat. No. 5,162,649, and can offer a resolution of up to 150 in a compact system, as described for example in Wu et al., Anal. Chem. 1998, 70, 4929-4938.

While the majority of ion mobility spectrometers operate at atmospheric pressure, there is a growing trend to accommodate them in vacuum, typically when they are used in tandem with mass spectrometry (MS), for example in hybrid IMS-MS instruments. This is driven by the ability to provide better ion confinement at low pressures using radio frequency (RF) electric fields, as disclosed for example in U.S. Pat. Nos. 6,914,241, 6,630,662. The IMS-MS configuration is a powerful analytical tool which employs mass spectrometry for further separating and/or identifying peaks in an ion mobility spectrum. More than two separation techniques may be combined with IMS, for example LC-IMS-MS and GC-IMS-MS.

Mass spectrometry has the further advantage of being able to deduce structural information about molecular ions by using activation methods to form structure-related fragment ions from the molecular ions. The fragment ions are characteristic of bond strength within the molecular ions. Typically, activation takes place by accelerating the ions at low pressure into a gas-filled RF multipole (typically RF-only). The center-of-mass collision energies may reach many eVs. The analyte or molecular ion of interest is then identified and optionally quantified according to the intensities of the characteristic fragments formed from the analyte.

The selectivity of IMS is low compared to the complexity of samples that are often typical within realistic matrixes. In many applications, samples are typically analyzed with electrospray ionization followed by IMS. Selectivity of IMS has been found to be not entirely orthogonal to accurate mass MS, as described in Fast ion mobility spectrometry and High resolution TOF MS, B. Kozlov, V. Makarov, I. Kurnin, A. Verenchikov, ASMS abstract, 2014 and further illustrated in Large-Scale Collision Cross-Section Profiling on a Traveling Wave lon Mobility Mass Spectrometer, Christopher B. Lietz, Qing Yu, Lingjun Li, J. Am. Soc. Mass Spectrom. (2014) 25, 2009-2019.

In an analogy to tandem MS-MS, several attempts have been made to enhance selectivity of IMS by arranging ion fragmentation in atmospheric pressure. Attempts to achieve analogous quality of fragmentation at atmospheric pressure compared to low pressure (vacuum) have generally not been very successful and have encountered various difficulties.

As described in V. Berkout et al, Int. J. Mass Spectrom, 325-327 (2012), p 113, and U.S. Pat. No. 8,188,423, free electrons and free radicals produced by a negative corona discharge lead to ECD or ETD-like fragmentation of peptide ions produced by an electrospray ion (ESI) source and separated from solvent and air by differential mobility (FAIMS). Along with the ECD/ETD fragments, collisionally-activated dissociation (CAD) type fragments can be formed depending on the gas temperature. Gas temperatures up to and greater than 300° C. were used in combination with the corona discharge. This fragmentation method appears to be highly sensitive to impurities in the ionic flow. Mass spectrometric analysis of the fragments under vacuum was described.

As described in B. D. Robb in Anal. Chem., 2014, 86 (9), pp 4439-4446, free electrons produced by UV lamp produce some amount of ECD or ETD-like fragmentation. Notably, ESI ions and solvent were injected into the reactor directly. However, UV lamp could not produce the fragmentation alone, but rather was used in combination with in-source CAD, also termed collisionally-induced dissociation (CID), and also supplemental activation in a collision cell of a Q-TOF mass spectrometer, which questions the mechanism and the utility of the method.

U.S. Pat. No. 6,797,943 describes an ion mobility device where several fragmentation methods can be used to break down an ion: such as using an ultraviolet (UV) or vacuum UV lamp, electron or ion beams, radioactive sources, discharge, etc. The device was designed to be used for analysis of proteins of biological weapons threats (e.g. viruses or bacteria) and therefore multiple charge states of the analyte were produced. The efficiency and robustness of the proposed fragmentation methods are questionable for the reasons mentioned above. Generally, a relatively large amount of energy is needed to ensure that fragmentation takes place. Furthermore, the ions are accumulated in a reservoir where they are exposed to the ion modification energy prior to admittance to the ion mobility drift chamber. A problem with this arrangement is that all the molecular ions are subjected to fragmentation simultaneously making analysis very difficult

U.S. Pat. Nos. 9,678,039 and 7,932,489 describe an ion mobility spectrometer in which a radio frequency (RF) electric field is applied together with thermal energy to obtain daughter ions. Very little detail is given on these daughter ions and from the position of the RF electrodes half-way along the drift tube it appears that the device is intended to modify or fragment ions by only improving desolvation or declustering of the incoming ions, i.e. freeing them from attached molecules of solvent, water or any other matrix.

A structure-selective shift of the ion mobility drift time is described in U.S. Pat. No. 8,242,442, with the objective being to separate overlapping compounds. Further ways to impose such a shift by ion-molecule interactions are also disclosed in US2010/0108877. Ion modification by strong electric fields is proposed in US2009/0039248, although the modification seems to relate mainly to clustering/declustering processes and cannot produce fragmentation into structure-related fragments.

Therefore, there is a need to provide improvements in ion mobility spectrometry and mass spectrometry. Against this background the present invention has been made.

### SUMMARY

According to an aspect of the invention there is provided a method of ion mobility spectrometry comprising:
providing a sample
generating molecular ions from the sample;
separating the molecular ions according to their mobility characteristics;
fragmenting at least some of the separated molecular ions to form sub-molecular fragment ions in a fragmentation zone;
separating at least some of the fragment ions according to their mobility characteristics;
wherein each stage of separating the molecular ions, fragmenting at least some of the separated molecular ions and separating at least some of the fragment ions is performed at a pressure of at least 50 mbar;
detecting at least some of the separated fragment ions; and
identifying at least one molecular ion based on its mobility characteristics and/or the mobility characteristics of at least one detected fragment ion. Preferably, the molecular ion is identified using the mobility characteristics of at least two of its detected fragment ions (e.g. two, three, four, or more fragment ions). Additionally, in some embodiments, one or more ratios of fragment ion intensities can also be used to identify the at least one molecular ion.

In certain aspects, the invention there is provided a method of ion mobility spectrometry according to claim 1 or claim 2.

According to another aspect of the invention there is provided an ion mobility spectrometer comprising:
an ion source for receiving a sample and generating molecular ions from the sample;
a first ion mobility separator for separating the molecular ions according to their mobility characteristics;
a fragmentation zone for fragmenting at least some of the separated molecular ions to form sub-molecular fragment ions;
a second ion mobility separator for separating at least some of the fragment ions according to their mobility characteristics;
wherein the first ion mobility separator, fragmentation zone and second ion mobility separator are adapted to be held at a pressure of at least 50 mbar in use; and a
detector for detecting at least some of the separated fragment ions.

The apparatus may further comprise a data processing system for receiving data from the detector representative of the ion mobility of detected molecular ions and/or fragment ions and processing the data. An ion mobility spectrum of the fragment ions can thereby be acquired (fragment IMS spectrum). By processing the data, the data processing system can thereby identify a molecular ion based on its ion mobility and/or the ion mobility of at least one, preferably at least two, even more preferably three to six, of its detected fragment ions. Additional confidence of identification may be enabled by reference or comparison of the acquired fragment IMS spectrum to a library of fragments (e.g. fragment IMS spectra or MS spectra) that has been created for a plurality of analytes (molecules) of interest. The method of identifying a molecular ion typically means that the method is one of targeted analysis, involving the detection of a known analyte (molecular ion), which has already been characterized and stored in a library or database. The library or database may be held locally, for example on the data processing system, or held remotely, such as on a cloud-based storage device or remote server.

The sample typically comprises a plurality of different molecules (i.e. different molecular species), which give rise to a plurality of different molecular ions in an ion source, which can be separated subsequently by their ion mobility in a first stage. The term molecular ions herein refers to ionized but non-fragmented molecules of the sample, which may also be referred to herein and in the art as parent ions or precursor ions. The fragment ions result from the fragmenting of the molecular ions and so are smaller sub-units of the molecular ions, i.e. sub-molecular fragments. Preferably at least two sub-molecular fragment ions are detected for a species of molecular ion and used to identify the molecular ion. The molecular ions may be derived from samples containing different molecules. The molecules may be selected from the following non-exhaustive list of examples: biopolymers, peptides, polypeptides, proteins, protein complexes, amino acids, carbohydrates, sugars, fatty acids, lipids, vitamins, hormones, polysaccharides, phosphorylated peptides, phosphorylated proteins, glycopeptides, glycoproteins, oligionucleotides, oligionucleosides, glycans, DNA, fragments of DNA, cDNA, fragments of cDNA, RNA, fragments of RNA, mRNA, fragments of mRNA, tRNA, fragments of tRNA, monoclonal antibodies, polyclonal antibodies, ribonucleases, enzymes, metabolites, antibiotics, pesticides, volatile organic compounds (VOCs), drugs and/or steroids. The sample may comprise at least 2, 5, 10, 20, 50, 100, 500, 1000, or 5000 different molecules.

The method of this aspect of the invention thus comprises a tandem IMS method. (i.e. IMS-IMS or IMS2). The ion mobility separation of the molecular ions and/or the fragment ions is typically caused by one or a combination of electric and/or gas flow fields. Herein, separating the molecular ions and/or separating at least some of the fragment ions according to their mobility characteristics includes any method or means of separating the ions that uses the mobility of the ions or a modification of the ions. Thus, it is based on separating ions by physical or chemical characteristics of ions alternative to or in addition to ion mass or mass/charge ratio. In some embodiments, the separation may comprise using combined ion mobility and mass characteristics. In some embodiments, modifiers, i.e. dopants, can be used that attach to one type of ion but not another and thus ions of initially the same mobility can become easily separated by different mobility after the modification. In some embodiments, the separation of ions can be caused by a combination of crossed electric and gas flow fields. In some embodiments, separating the molecular ions and/or separating at least some of the fragment ions according to their mobility characteristics can be performed by using one of the following: ion mobility separation in a buffer gas-filled drift tube using an axial DC potential along the drift tube; ion mobility separation in a buffer gas-filled drift tube using a travelling DC wave along the drift tube (e.g. using combined mobility and mass characteristics); differential mobility as in field-asymmetric ion mobility spectrometry (FAIMS); cross-flow differential mobility analysis (DMA); transverse modulation ion mobility spectrometry; and trapped ion mobility spectrometry (TIMS). Thus, references herein to ion mobility separation mean separation generally according to mobility characteristics of the ions.

In a preferred embodiment described below, the ion mobility separation, in either or preferably both stages of IMS, may be caused by a combination of crossed electric and gas flow fields. Thus, separating the molecular ions and/or separating at least some of the fragment ions may be caused by a combination of crossed electric and gas flow fields. Accordingly, the first ion mobility separator and/or second ion mobility separator may comprise crossed electric and gas flow fields.

Preferably, each stage of separating the molecular ions according to their ion mobility, fragmenting at least some of the separated molecular ions and separating the fragment ions is performed at a pressure of at least 100 mbar, more preferably at least 250 mbar, even more preferably at least 500 mbar and most preferably at atmospheric pressure (which may be approximately 1000 mbar). Thus, the first ion mobility separator, fragmentation zone and second ion mobility separator preferably are adapted to be held at a pressure of at least 100 mbar, more preferably at least 250 mbar, even more preferably at least 500 mbar and most preferably at atmospheric pressure (which may be approximately 1000 mbar) in use.

The first stage of ion mobility separation (IMS) comprises separation of the molecular ions. The first stage IMS may comprise separation of the molecular ions in time and/space based on their ion mobility.

The first stage of IMS may comprise introducing pulses of the molecular ions (e.g. pulsing or gating using an ion gate) into a buffer gas-filled drift tube, transporting the molecular ions through the drift tube, wherein the ion pulses separate using an axial DC potential gradient along the drift tube, e.g. created by a series of ring electrodes axially spaced apart along the length of the spectrometer, for example as disclosed in patents U.S. Pat. Nos. 5,162,649, 6,992,284 and 6,479,815. The ions reach the exit of the drift tube at different times dependent on their ion mobility. The first stage IMS may comprise a drift tube wherein a travelling DC wave is applied to select molecular ions of certain mobility, for example as disclosed in U.S. Pat. No. 5,789,745. The buffer gas is often arranged flowing in the opposite direction to the direction of ion travel in these types of IMS. While such types of first stage IMS may use pulses of ions, other types of first stage IMS use continuous ion beams. The ions may then be separated in space based on their ion mobility.

One type of IMS suitable for the first stage of separating the molecular ions is field-asymmetric ion mobility spectrometry (FAIMS), wherein a continuous beam of the molecular ions is separated in an asymmetric oscillating electric field on the basis of an ion mobility non-linearity with respect to the electric field, for example as disclosed in U.S. Pat. Nos. 5,420,424, 6,690,004, WO00/08454.

A preferred type of IMS suitable for the first stage of IMS is a differential mobility analyzer (DMA), which separates a continuous beam of molecular ions, wherein the molecular ions are separated in space in a crossed (i.e. transverse) DC electric field and gas flow, for example as disclosed in U.S. Pat. Nos. 5,869,831 and 6,787,763.

Another type of first stage of IMS is transverse modulation IMS in which a continuous beam of molecular ions is filtered to allow passage of only those ions that return strictly on an axis after passing through a combination of axial DC field and perpendicular RF field, for example as disclosed in U.S. Pat. No. 8,378,297, US2016/0133451.

The second stage of IMS, i.e. separation of the fragment ions, may use any of the types IMS described above for the first stage. As with the first stage IMS, a preferred type of IMS suitable for the second stage is a differential mobility analyzer (DMA), or other IMS that separates ions in space.

Accordingly, in some embodiments, separating the molecular ions and/or separating at least some of the fragment ions according to their ion mobility are each performed by using one of the following: ion mobility separation in a buffer gas-filled drift tube using an axial DC potential along the drift tube; ion mobility separation in a buffer gas-filled drift tube using a travelling DC wave along the drift tube; field-asymmetric ion mobility spectrometry (FAIMS); differential mobility analysis (DMA); transverse modulation ion mobility spectrometry.

A gas circulation loop may be provided, for example wherein a gas flow that provides a gas flow field in the first stage IMS can be circulated to the second stage IMS to provide the gas flow field for the second stage and then circulated back to the first stage IMS, e.g. in a closed loop, to provide the gas flow field in the first stage IMS, and so on. Thus, a closed gas circulation loop for continuously circulating gas between the first and second ion mobility separators is preferably provided. A compressor may be provided in the loop to circulate the gas. This works well with a dual DMA design (each stage of IMS uses a DMA). Thus, a gas circulating in a closed loop can be used for both separating the molecular ions according to their ion mobility and separating at least some of the fragment ions according to their ion mobility.

An ion mobility spectrometer according to the invention may be operated on its own as a means for ion separation, or it may be used in combination with other separation devices in hybrid IMS instruments. In some embodiments, a sample separation device, such as a liquid or gas chromatograph for example, may be positioned upstream of the ion mobility spectrometer of the invention and connected to the ion source thereof. Thus, the sample may be separated based on LC or GC prior to the sample being ionized to produce the molecular ions. Examples of hybrid IMS instruments therefore can include those based on liquid chromatography IMS (LC-IMS) or gas chromatography IMS (GC-IMS), more particularly wherein the IMS is the tandem IMS according to aspects of the present invention: e.g. LC-IMS-IMS or GC-IMS-IMS. A preferred step comprises separating the sample using a liquid or gas chromatography prior to generating molecular ions.

The fragmentation stage is preferably an atmospheric pressure fragmentation. The fragment ions are preferably produced while transporting the molecular ions through the fragmentation zone by electric and/or gas flow fields. Preferably, the fragmentation is thermal fragmentation. Thus, the fragmentation zone is preferably a thermal fragmentation zone and especially a thermal atmospheric pressure fragmentation (TAPF) zone. More preferably, the fragmentation is thermal fragmentation in a heated or hot gas, wherein the gas temperature T is at least 200° C., 300° C., 400° C., or 500° C., e.g. up to 1000° C., preferably 400-700° C. or more preferably 500-700° C. Thus, the fragmentation zone comprises a heated or hot gas at the aforesaid temperatures. Thus, in the method of the invention, fragmenting at least some of the separated molecular ions comprises transporting the molecular ions through the fragmentation zone by an electric and/or gas flow field, wherein the fragmentation zone comprises a gas at a temperature of at least 200° C., 300° C., 400° C., or 500° C., preferably 400-700° C. or more preferably 500-700° C.

Where the gas temperature is not uniform in the fragmentation zone, the gas temperature refers to an average gas temperature that the ions experience as a collection as they travel through the gas, thus providing an effective fragmentation temperature, which averages fragmentation efficiency over a non-uniform spatial temperature profile for spatially spaced ion flows. The temperature of the fragmentation zone is thus represented by a gas temperature therein. On the basis of experiments, preferred conditions have been found in which fragmentation occurs at temperatures of at least 500° C. and with interaction times of the ions in the gas of at least 1 millisecond (ms), preferably at least 2 ms. The gas temperature can be measured, for example, by one or more thermocouples positioned in the gas inside the fragmentation zone, or positioned upstream and downstream (in the gas flow sense) of the fragmentation zone. In some embodiments, the heated gas may provide a gas flow field for transporting the molecular and/or fragment ions through the fragmentation zone, optionally in combination with an electric field. In some embodiments, the heated gas may provide a crossed (transverse) gas flow field that is substantially transverse to an electric field where the molecular and/or fragment ions are transported through the fragmentation zone using the electric field. The fragmentation zone may be located within a fragmentation chamber that is separate from and located between the first and second ion mobility separators, which may be located in different chambers. Alternatively, the fragmentation zone may be located within the same chamber as either or both of the first and second ion mobility separators.

Further preferably, the fragmentation is thermal fragmentation in the absence of any additional (i.e. reagent) charged species (e.g. electrons or reagent ions, especially ions of opposite polarity to the molecular ions) or electromagnetic radiation in the fragmentation zone. Thus, preferably the fragmentation zone contains ions only of one polarity (the polarity of the molecular ions being fragmented), unlike an ETD cell for example. The molecular ions generally have the same polarity as each other (i.e. all molecular ions are positive ions or all molecular ions are negative ions). The fragmentation zone preferably contains ions of only that one polarity. Thus, the fragmentation does not comprise ETD for example. The fragmentation thus occurs preferably by thermal fragmentation only.

Additional or reagent charged species herein means electrons or ions derived from a source other than the sample, for example reagent ions that are derived from a reagent gas (argon for example) using a corona discharge or glow discharge. Thus, in contrast to prior methods of atmospheric pressure fragmentation such as those using corona discharge or UV light irradiation, the present invention preferably provides a fragmentation stage in which the molecular ion are not interacted with any reagent charged species or electromagnetic radiation (photons).

The present invention may produce fragment ions that are similar to fragment ions that would be obtained by collisionally-induced dissociation (CID), eg. producing: b- and y-fragments, and optionally a-fragments, of peptides. However, whereas conventional CID is generally not effective at atmospheric pressure, and even above 50 mbar, the present invention can produce similar fragments at atmospheric pressure by interacting the molecular ions with a heated gas alone. The invention works surprisingly well using thermal energy alone. The invention can even fragment certain molecular ions efficiently that CID is not able to effectively fragment even at lower pressures. The thermal fragmentation of the present invention can provide effective fragmentation for a range of molecular ion masses and charges (in some embodiments largely independent of these factors). Whereas the collision energy in CID is typically many tens of eV, the collisions of the molecular ions and the heated gas occur typically at an energy not greater than a few tenths of eV. Thus, typically, the collisions of the molecular ions and the heated gas occur at an energy <1 eV, preferably <0.7 eV and more preferably <0.5 eV.

The residence time of the molecular ions in the fragmentation zone (e.g. the residence or interaction time of the molecular ions in the heated gas) is preferably in the range of 0.1-10 millisecond (ms), particularly 0.1-5 millisecond (ms), more preferably 0.3-5 ms, 0.5 ms-5 ms or 1 ms-5 ms, or 1 ms-3 ms. Residence time preferably should be at least 0.1-1 ms (e.g. at least 0.1 ms, at least 0.5 ms, or at least 1 ms), especially for ions of m/z in a range 400-700. Residence time preferably should be up to 5 ms (or higher, e.g. up to 10 ms) or up to 3 ms, particularly 0.1-3 ms, or up to 2 ms, particularly 0.1-2 ms. Short residence times of the order of 0.1-5 ms or 0.1-3 ms, such as about 1 ms, are desired to improve the sensitivity of the method. At relatively higher pressures, for example atmospheric pressure, the ion charge density is inversely proportional to the residence time due to space charge self-expansion. Furthermore, electrospray aerosols evaporate in about 1 ms at room temperature and within mobility devices it is common to have residence times under 1 ms. Thus, short residence times in the fragmentation zone of 0.1-5 ms or 0.1-3 ms are desired to maintain the ion signal. At these shorter residence times, which are shorter than employed in the prior art, higher temperatures must be used to effect thermal fragmentation. The Arrhenius formula can be rearranged as follows, linking residence time in the fragmentation zone, T (tau), with the temperature of fragmentation, T, i.e. temperature of the heated gas (temperature to achieve 50% fragmentation), the molecular enthalpy of fragmentation AH and the vibration period TO:

$$τ = τ 0 * exp ( - Δ H / kT )$$

which rearranges to

$$- T * ln ( τ ) = - T * ln ( τ 0 ) + Δ H / k$$

Preferably, the left side of the above formula, T*ln(1/τ), is above 3200, with units of T in Kelvin (K) and T in seconds. Optionally, T*ln(1/τ) is below 7600. More preferably, T*ln(1/τ), is above 4000, or above 5000, or above 6000. For example, for a temperature of fragmentation, T, of 800 K and residence time, T, of 1 ms, T*ln(1/τ) is 800*In (1/0.001)=5526.

On average, fragmentation rate may double per 15° C. Especially preferred is a residence time in the heated gas of at least 0.1 ms, at least 0.5 ms or at least 1 ms, up to 3 ms or up to 5 ms. Where a heated gas jet is used to fragment the ions, the residence time in the fragmentation zone may be less than the residence time where the ions pass through a heated channel, tube or capillary containing the heated gas.

In some embodiments, the invention may comprise detecting more than one fragment ion from a given or each molecular ion, either sequentially (e.g. where the ion mobility separator separates the fragment ions in time, or where the ion mobility separator separates the fragment ions in space and the fragment ions are sequentially scanned to a detector) or in parallel (e.g. where the fragment ions are separated in space).

For parallel detection, for example, the detector may comprise an array detector comprising a plurality of individual detectors spatially separated in a one-dimensional (1D) or two-dimensional (2D) array. For example, the second ion mobility separator may be a differential mobility analyser (DMA), or generally an IMS that separates a continuous beam of ions in space based on their ion mobilities (for example an IMS which separates a continuous beam of ions, wherein the ions are separated in space in a crossed (i.e. transverse) DC electric field and gas flow), such that two or more fragment ions are detected in parallel along a 1D or 2D array detector. In this way parallel reaction monitoring (PRM) or multiple reaction monitoring (MRM) may be performed.

In another preferred type of embodiment, a single detector (i.e. single channel detector) is provided and the fragment ions are sequentially scanned to the detector, for example by using a second ion mobility separator that is a differential mobility analyser (DMA), or generally an IMS that separates a continuous beam of fragment ions in space based on their ion mobilities (for example an IMS which separates a continuous beam of ions, wherein the ions are separated in space in a crossed (i.e. transverse) DC electric field and gas flow), and scanning or stepping an electric field thereof. Thus, the detector can comprise a single detector and the second ion mobility separator comprises an ion mobility separator that separates a continuous beam of fragment ions in space based on their ion mobilities having an electric field that can be scanned for sequentially scanning fragment ions to the single detector.

Furthermore, in some embodiments, additionally or alternatively to detecting more than one fragment ion as previously described, more than one molecular ion separated by the first ion mobility separator may be fragmented, either sequentially (e.g. where the ion mobility separator separates the molecular ions in time, or where the ion mobility separator separates the molecular ions in space and the molecular ions are sequentially scanned to the fragmentation zone) or in parallel (e.g. where the molecular ions are separated in space). Thus, the molecular ions may be separated and fragmented sequentially or in parallel.

For the purpose of parallel fragmentation, for example, the fragmentation zone may comprise an array of fragmentation channels (two or more channels). There may be a one-dimensional (1D) or two-dimensional (2D) array of fragmentation channels. The array of fragmentation channels may comprise a plurality of individual channels each separated from one or more adjacent channels by one or more walls. For example, the first ion mobility separator may be a differential mobility analyser (DMA), or generally an IMS that separates a continuous beam of molecular ions in space based on their ion mobilities (for example an IMS which separates a continuous beam of ions, wherein the ions are separated in space in a crossed (i.e. transverse) DC electric field and gas flow), such that two or more molecular ions are fragmented in parallel in the array of individual fragmentation channels. The array of fragmentation channels thus receives the separated molecular ions in parallel.

In another preferred type of embodiment, a single fragmentation channel is provided and the molecular ions are sequentially scanned into the fragmentation channel, for example by using a first ion mobility separator that is a differential mobility analyser (DMA), or generally an IMS that separates a continuous beam of molecular ions in space based on their ion mobilities (for example an IMS which separates a continuous beam of ions, wherein the ions are separated in space in a crossed (i.e. transverse) DC electric field and gas flow), and scanning or stepping an electric field thereof. Thus, the fragmentation zone can comprise a single fragmentation channel and the first ion mobility separator comprises an ion mobility separator that separates a continuous beam of molecular ions in space based on their ion mobilities having an electric field that can be scanned for sequentially scanning molecular ions into the single fragmentation channel.

In some embodiments, more than one molecular ion is separated in space along a first direction of separation (x) and more than one fragment ion is separated in space along a second direction of separation (y), wherein the first and second directions are not the same, preferably are substantially orthogonal to each other. For example, the first ion mobility separator may be a differential mobility analyser (DMA), or other IMS that separates a continuous beam of molecular ions in space based on their ion mobilities, that separates the molecular ions along the first direction of separation (x) and the second ion mobility separator may be a differential mobility analyser (DMA), or other IMS that separates a continuous beam of ions in space based on their ion mobilities, that separates the fragment ions along the second direction of separation (y), preferably perpendicular to x. The detector may be provided in such embodiments as a 2D array of detectors wherein individual detectors extend in the x and y directions. In some embodiments, the molecular ions are separated and fragmented in parallel along the first direction of separation (x) and more than one fragment ion from each molecular ion is separated and detected in parallel along the second direction of separation (y), wherein the detector comprises a two-dimensional array detector, as described above.

Typically, for the separated molecular ions, some but not all of the molecular ions are fragmented. Typically, unfragmented molecular ions and fragment ions are transmitted through the second stage of ion mobility separation (second ion mobility separator) and detected. Thereby the fragment ion mobility spectrum detected (typically stored and/or output after processing the data from the detector in the data processing device) typically comprises peaks for unfragmented molecular ions and one or more fragment ions (preferably two or more fragment ions).

In some preferred embodiments, the invention further comprises operating in a single IMS mode (IMS1), before or after operating in the tandem IMS mode (IMS2). In the single IMS mode (IMS1), for a period the molecular ions are not fragmented but are merely separated, e.g. by the first and/or second stage of ion mobility separation as described, and detected as molecular ions. For this purpose, for a period the molecular ions either bypass the fragmentation zone or, preferably, are transmitted through the fragmentation zone, wherein the conditions are adjusted for a period so that they do not permit fragmentation.

For the bypass embodiments, the spectrometer may comprise ion optics upstream and downstream of the fragmentation zone that are operable to direct the molecular ions to follow a path that bypasses the fragmentation zone. The molecular ions are separated by the first and/or second stages of ion mobility separation respectively upstream and downstream of the path that bypasses the fragmentation zone. Further ion optics downstream of the fragmentation zone may allow the ions that follow the bypass path to be directed to the detector, either via the second ion mobility separator or avoiding the second ion mobility separator. Where the molecular ions are separated by the first stage of IMS but not fragmented they may be further subjected to the second stage of IMS in the second ion mobility separator to further increase their separation, or they may be detected substantially without further ion mobility separation after the first stage.

For some embodiments where the molecular ions are transmitted through the fragmentation zone, wherein the conditions do not permit fragmentation, the gas conditions, especially the temperature of the gas, in the fragmentation may be adjusted so that they do not permit fragmentation. This is preferably performed in a pulsed manner. This may be accomplished in numerous ways. For example, the heated gas may be applied to the fragmentation zone in pulses, wherein when the pulse of heated gas is present in the fragmentation zone fragmentation occurs and between the pulses of heated gas fragmentation does not occur. In another example, a pulse of cooler gas (than the heated gas) can be mixed with the heated gas in the fragmentation zone in order to sufficiently reduce the gas temperature during the pulse so that fragmentation does not occur. A pulsed switching of the thermal fragmentation may be provided by one or more pulsed valves for pulsing one or more gas streams. For example, one or more pulsed valves may provide a hot gas pulse, or one or more pulsed valves may provide a cold gas pulse to provide pulsed mixing of cold and hot gas streams. Pulsed valves used in this way may be able to switch the temperature between a fragmenting temperature and a non-fragmenting temperature, for example in a rapid manner, such as in a time scale of tens of ms (e.g. 10-100 ms).

Thus, the fragmentation may be switched on or off as required. In the above embodiments, wherein the fragmentation zone comprises an array of fragmentation channels, the fragmentation may be switched on in one or more channels whilst it is switched off in one or more other channels. In some embodiments, the fragmentation may be alternately either switched on for all fragmentation channels together or switched off for all channels together, for example in embodiments where the channels have a common gas flow. In some embodiments, wherein the molecular ions are separated in time by the first stage IMS, the fragmentation can be switched on for selected molecular ions only, i.e. not all molecular ions. In this way, the fragmentation zone conditions can be varied with time to fragment selected molecular ions based on their ion mobility and/or based on their chromatographic retention time where the sample has been subjected to chromatographic separation.

A further dimension of analysis may be provided by performing so-called thermal scans, that is: detecting the fragment ions as a function of gas temperature in the fragmentation zone. In this way, the means for heating or the heater can be controlled to change the temperature of the gas so as to scan the temperature of the gas, while detecting the fragment ions. In this way, the described analysis of the molecular and fragment ions can be performed at a plurality of different fragmentation zone gas temperatures and a degree of fragmentation recorded and/or plotted against the temperature. The degree of fragmentation may be measured and expressed, for example, as a particular (or more than one) fragment ion intensity, or the total fragment ion intensity (sum of all fragment ion intensities) or a ratio of one or more fragment ion intensities to molecular ion intensity. Different molecular ions not only produce different fragmentation patterns (i.e. characteristic structure-related fragment ions) but the degree of fragmentation may also show a characteristic dependence on the gas temperature used for the thermal fragmentation. In this way, a curve of fragmentation versus temperature can be determined for a molecular ion. This can be used to help identify the molecular ion, preferably when used with the ion mobilities of the molecular and/or fragment ions.

In some embodiments, the invention enables monitoring of fast or ultra-fast processes (e.g. mobile lab applications, airborne profiling, technological control, airport security, exhaust optimization, monitoring air at dangerous manufacturing processes, etc). In some such embodiments, the IMS-IMS spectrometer according to the invention can configured to select one more specific molecular ions in the first stage IMS (e.g. in parallel as described), e.g. of a target sample molecule, and to select and detect one or more (preferably two or more) characteristic fragment ions for each selected molecular ion. Thus, the invention effectively becomes a 2D sensor tuned to specific ion detection channels.

In some embodiments, it can be seen that the method may comprise ion mobility separation of molecular ions at gas pressures above 50 mbar comprising: generating a flow (preferably a continuous flow) of molecular ions from a sample (preferably by electric field and optionally gas flow), separating the ions according to their ion mobility in electric and/or gas flow fields, fragmenting at least some of the separated ions to produce fragment ions, separating at least some of the fragment ions, and detecting the fragment ions, e.g. to generate a fragment ion spectrum, wherein: the fragment ions are created while transporting the molecular ions through a gas-filled fragmentation zone at gas pressures above 50 mbar by electric and/or gas flow fields; the fragment ions are separated according to their ion mobility in electric and/or gas flow fields at gas pressures above 50 mbar; and wherein at least one molecular ion is identified based on its ion mobility and the ion mobility of at least two characteristic fragment ions. Optionally, the ratios of fragment ion intensities can used to identify the at least one molecular ion. As described above, the fragmentation is preferably implemented without an additional ionization step (i.e. without additional charged species or electromagnetic radiation). The fragmentation may be carried out in a flow of heated gas with temperatures above 200° C., or above 300° C., or above 400° C.

In some embodiments, the molecular ion can be identified by comparing its fragment ion IMS spectrum (e.g. a ratio of fragment ion intensities, preferably comprising an intensity of the molecular (parent) ion, i.e. fragment to molecular ion ratio) with a previously created library of fragment ion IMS spectra. For example, a ratio of fragment ion intensities of particular fragment ions, and of the molecular ion, are characteristic of the molecular ion. Such an example is shown in FIGS. 9 and 10 and described further below. Substantially parallel curves in the log plot of fragment intensity versus fragmentation temperature for various fragments means that their ratio stays substantially constant over a wide range of temperatures. Molecule-specific set of fragments and individual intensity ratios of fragment ions versus molecular ion are well known, e.g. from tandem mass spectrometry. Thus, a ratio of fragment ion intensities is characteristic for a compound (molecular ion). A characteristic temperature, depending on the target compound, to obtain sufficient intensity of the characteristic fragments, typically occurs at about 30-50% of parent ion survival (70-50% fragmentation).

Due to the typically limited selectivity of IMS, the number of detected and processed fragments preferably should be at least two (more preferably three or more), and it is more preferable to detect multiple fragments in parallel (e.g. using a system as shown in FIG. 1). Prior development of the method can determine the minimum number of fragments needed for reliable identification of the molecular ion.

Preferred features of such identification methods thus include one or more of the following: parallel (i.e. multi-channel) IMS at the second stage of IMS separation; analyzing one or more intensity ratios of a number of channels (fragments), preferably at least a ratio of two channels and preferably at least two ratios; detecting a number of channels necessary for reliable identification (based sample and matrix complexity), more preferably detecting more than two fragment ion channels (even more preferably detecting in parallel). Specific criteria, can be developed for each application, such that sometimes it is acceptable to include false positive (for rapid screening prior to expensive accurate analyses) while sometimes it is essential to detect the correct signal in a sufficient number of channels.

In such embodiments, the fragmentation conditions can be adjusted, with the help of a calibrant, to provide a fragment spectrum to match to at least one of those included in the library. For example, for the purpose of targeted analysis, a known sample (calibrant) that has a fragment spectrum in the library can be analysed and its fragment spectrum obtained under first fragmentation conditions. The fragmentation conditions (e.g. temperature of the fragmentation zone and/or ion residence time in the zone) can be adjusted until the fragment spectrum of the calibrant sufficiently closely matches the fragment spectrum of the calibrant in the library at a certain temperature setting. Alternatively, the fragment ion ratio can be calibrated based on the fragmentation degree of the molecular ion in the first calibration experiments. Thus, the calibrant is used as a type of molecular thermometer to establish the correct temperature and/or other conditions for fragmentation. The degree of molecular ion fragmentation may be used as such a calibrant or molecular thermometer as well. As seen in FIG. 9, a fragment ion ratio varies with temperature much slower than the degree of fragmentation. Indeed, the curves for fragment ions stay nearly parallel over a wide temperature range, compared to the curve for fragmentation of the molecular ion. This means that the degree of ion fragmentation can serve as the temperature calibrant or thermometer. The aspect allows adjustment of the fragmentation temperature to optimize the sensitivity of the method for target compounds, especially where fast adjustments of the reactor temperature can be achieved, for example by mixing hot and cold gas jets. While the method preferably comprises analysis of at least two fragments, it is anticipated that a larger number of fragments are to be used for improved selectivity and accounting a limited separation power of ion mobility separators. FIG. 1, described below, presents an example of an apparatus for parallel detection of multiple fragments. In targeted analyses, a required number of detected fragments can be determined in prior calibration experiments for example during development of the analytical method, and accounting for the complexity of any characteristic matrices. In the case of parallel detection of multiple fragment ions, the analytical method preferably forms one or more detection criteria, selecting whether false positive identifications are acceptable, as in case of preliminary screening, or whether they are not acceptable such that all characteristic fragments must be detected, as in a case of analysis of evidence for use in court proceedings.

The detector for detecting the ions (molecular ions and/or fragment ions) may comprise a microchannel plate (MCP), e.g. a single MCP or dual MCP, such as a chevron pair MCP, or a discrete dynode electron multiplier. The detector may comprise a scintillator (preferably a fast scintillator) to convert ions or electrons to photons and a photon detector such as a photomultiplier tube (wherein a photon packet is ultimately converted back into an electron packet for detection). In some embodiments, the detector may comprise a microchannel plate or an electron multiplier, followed by a scintillator and a photon detector. Other ion detectors known in the art may be used.

The apparatus may further comprise a data processing system for receiving data from the detector representative of the ion mobility of detected molecular ions and/or fragment ions and processing the data. By processing the data, a spectrum of the detected ions (fragment ion spectrum) may thereby be produced and optionally stored and/or output. By processing the data, the data processing system can thereby identify a molecular ion based on its ion mobility and/or the ion mobility of at least one, preferably at least two, of its detected fragment ions. The data processing device may perform comparison of the fragment ion spectrum to a library of fragments or fragment ion spectra to identify a molecular ion, as described below. The data processing device may comprise an instrument interface, which is adapted to send commands to or operate the spectrometer and optionally a separation device such as a liquid or gas chromatograph that is operably connected to the spectrometer (such as to the ion source thereof). As mentioned, the data processing system is configured to receive measured data from the detector, e.g. via the instrument interface. The data processing device may comprise a storage unit for storing data in data sets. Connection between the data processing device and the spectrometer and/or chromatograph may be established by a wire or a glass fibre or wirelessly via radio communication. Preferably, the data processing device further comprises visualization means, in particular a display and/or a printer, and interaction means, in particular a keyboard and/or a mouse, so that a user can view and enter information. When the data processing device comprises visualization means and interaction means, operation of the spectrometer is preferably controlled via a graphical user interface (GUI). The data processing device can be realized as a personal computer or in a distributed form with a number of processing devices interconnected by a wired or wireless network, so that the processor unit may contain a plurality of processors. The processors are preferably implemented in an object-oriented programming language such as C# or C++; frameworks such as .Net may be used. The storage unit is adapted to store measured data sets and preferably comprises memory devices which save information in the form of electrical charges, such as a random access memory, and/or memory devices which save information in the form of magnetic domains, such as a hard drive.

Further aspects of the invention will now be described. The thermal fragmentation stage described herein, that is comprising a heated gas at pressure of at least 0.01 or 0.1 or 1 or 10 or 50 mbar and preferably atmospheric pressure, wherein the gas temperature T is at least (preferably above) 200° C., 300° C., or 400° C., or 500° C. and wherein the fragmentation occurs in the absence of reagent charged species (electrons or reagent ions, especially ions of opposite polarity) or electromagnetic radiation, can be utilised in methods of ion mobility separation and ion mobility spectrometers other than the embodiments described above. Furthermore or alternatively, the fragmentation stage may be combined with one or more stages of mass analysis, i.e. separation of ions based on the mass-to-charge ratio.

Accordingly, in a further aspect of the present invention there is provided a method of spectrometry, e.g. ion mobility separation or mass spectrometry, comprising:
generating molecular ions using an ion source, preferably at a pressure of 0.01 mbar or above, or 0.1 mbar or above, or 1 mbar or above, or 10 mbar or above, preferably 50 mbar or above, especially atmospheric pressure;
introducing at least some of the molecular ions into a fragmentation zone, wherein the temperature is above 200° C. (or preferably above 300° C., or above 400° C. or above 500° C.) and is filled with a gas at a pressure of 0.01 mbar or above, or 0.1 mbar or above, or 1 mbar or above, or 10 mbar or above, preferably 50 mbar or above
fragmenting at least some of the molecular ions in the fragmentation zone to form sub-molecular fragment ions;
separating the fragment ions; and
detecting the separated fragment ions. The molecular ions generally have the same polarity as each other (i.e. all molecular ions are positive ions or all molecular ions are negative ions). The fragmentation zone preferably contains ions of only one polarity, i.e. the polarity of the molecular ions. Thus, the fragmentation does not comprise ETD for example. The fragmentation occurs preferably by thermal fragmentation only.

Accordingly, in a still further aspect of the present invention there is provided a spectrometer, e.g. an ion mobility or mass spectrometer, comprising:
an ion source for generating molecular ions, preferably at a pressure of 0.01 mbar or above, or 0.1 mbar or above, or 1 mbar or above, or 10 mbar or above, preferably 50 mbar or above, especially atmospheric pressure;
a fragmentation zone for receiving at least some of the molecular ions, preferably in the absence of ions of opposite polarity to the molecular ions, wherein the temperature is above 200° C. (or preferably above 300° C., or above 400° C. or above 500° C.) and is filled with a gas at a pressure of 0.01 mbar or above, or 0.1 mbar or above, or 1 mbar or above, or 10 mbar or above, preferably 50 mbar or above for fragmenting at least some of the molecular ions in the fragmentation zone to form sub-molecular fragment ions; and
an ion mobility separator or mass analyser for separating the fragment ions and detecting the separated fragment ions.

In a yet further aspect, there is provided a method of analysing molecular structure comprising: thermally fragmenting ions in a gas at a pressure 10 mbar or above to produce thermal fragment ions, wherein the gas temperature is controlled to be at least 200° C., followed by analyzing mass and/or mobility characteristics of at least one fragment ion. Preferably, this method comprises a step of molecular identification by comparing one or more acquired mass and/or mobility spectra of the at least one fragment ion to a library of mass and/or mobility spectra of thermal fragments and finding a closest match between an acquired spectrum and a library spectrum. Preferably, the ions are thermally fragmented by flowing the ions through the gas and ions in the flow interact with the gas for a time from 1 to 10 ms.

The features of the previously described aspects of the invention are optionally applicable to the further aspects of the invention. For instance, the described features of the sample, ion source, first stage of ion mobility separation of the molecular ions, fragmentation zone, fragmentation conditions, second stage of ion mobility separation of the fragment ions, the detector and/or data processing device are independently applicable to the further aspects of the invention.

Alternatively, the further aspects of the invention may be combined with separating the fragment ions using a mass analyser in place of, or in addition to, the ion mobility separation of the fragment ions. Thus, in some embodiments, separating the fragment ions and detecting the separated fragment ions is performed by an ion mobility separator or a mass analyser, i.e. separation is based on ion mobility characteristics or mass-to-charge ratios of the ions. The mass analyser can determine the mass-to-charge ratio of the ions. Thus, the stage of separating the fragment ions may be performed by IMS or mass spectrometry (MS), i.e. by an ion mobility separator or a mass analyser. Furthermore, in the further aspect of the invention, the molecular ions may be separated before fragmentation based on IMS or MS, i.e. by an ion mobility separator or a mass selector (such as a quadruple mass filter, or other known mass selector or mass filter) located between the ion source and the fragmentation zone. Thus, in some embodiments, the molecular ions are separated by an ion mobility separator or a mass selector (downstream of the ion source) prior to fragmenting at least some of the molecular ions in the fragmentation zone. One preferred embodiment comprises IMS-thermal fragmentation-MS, i.e. wherein the molecular ions are separated by an ion mobility separator prior to fragmenting at least some of the molecular ions and wherein separating the fragment ions and detecting the separated fragment ions is performed by a mass analyser.

The stage or stages of MS analysis are typically performed at pressures of 1 mbar or less. For some types of MS analysis much lower pressures are required (e.g. 10⁻³ mbar or less, e.g. 10⁻⁴ mbar or less, e.g. 10⁻⁵ mbar or less, e.g. 10⁻⁶ mbar or less, e.g. 10⁻⁷ mbar or less, e.g. 10⁻⁸ mbar or less) including ultra-high vacuum (UHV) for some MS analysis techniques (e.g. 10.9 mbar or less). Therefore, in such embodiments, one or more stages of pressure reduction (vacuum pumped chambers) may separate the fragmentation zone and the mass analyser. The mass analyser may be pumped by one or more turbomolecular pumps for example. The mass analyser, which separates the ions based on their mass-to-charge ratio can comprise one or more of the following types of mass analysers: an ion trap, RF ion trap, electrostatic ion trap, electrostatic orbital trap (such as an Orbitrap™ mass analyser), Fourier transform (FTMS) analyser, Fourier transform ion cyclotron resonance (FT-ICR) analyser, time of flight (TOF) analyser, linear TOF, orthogonal acceleration TOF (OA-TOF), reflectron TOF, multi-reflection TOF (MR-TOF), quadrupole mass filter, or magnetic sector mass analyser. Preferably, the mass analyser is capable of high resolution and accurate mass (HR-AM). For example, a mass analyser that is capable of resolving power >25,000 or >50,000 or >100,000 or >200,000 and mass accuracy <10 ppm, or <5 ppm or <2 ppm. Preferably, the mass spectrometer comprises a mass analyser that is capable of measuring all of the m/z of interest in one acquisition or scan. Preferred mass spectrometers comprise an electrostatic ion trap, electrostatic orbital trap, or an FT-ICR, or a TOF such as a single-reflection or multi-reflection (MR)-TOF (preferably MR-TOF). Ion detectors that are conventional for such mass analysers may be used to detect the ions separated by the mass analyser.

The further aspects of the invention preferably comprises identifying a molecular ion based on its ion mobility or mass-to-charge ratio and/or the ion mobility or mass-to-charge ratio of at least one, preferably at least two, especially three to six, of its detected fragment ions. A preferred embodiment comprises identifying a molecular ion based on its ion mobility and the ion mobility of at least one, preferably at least two, of its detected fragment ions. Another preferred embodiment comprises identifying a molecular ion based on its ion mobility and the mass-to-charge ratio of at least one, preferably at least two, of its detected fragment ions. Still another preferred embodiment comprises identifying a molecular ion based on its mass-to-charge ratio and the mass-to-charge ratio of at least one, preferably at least two, of its detected fragment ions.

Some preferred embodiments for higher analysis specificity include tandem IMS (wherein each IMS stage comprises one of: gated IMS, FAIMS, or DMA) with thermal atmospheric pressure fragmentation (TAPF) in-between, or a hybrid IMS-MS with TAPF in-between, preferably where the IMS comprises one of: FAIMS, gated IMS, or DMA. In one such embodiment, a FAIMS-TAPF front end can be employed for MS instruments. A preferred embodiment has a hybrid configuration of IMS-Thermal Fragmentation-MS and especially LC-IMS-Thermal Fragmentation-MS, which is particularly useful for compound identification via fragment libraries. Generally, the use of MS is particularly useful for compound identification via fragment libraries

In another type of embodiment, the fragmentation zone (TAPF) can be provided in the ion source itself, e.g. at an interface of the ion source, for example in an electrospray ion (EI) source by extending the nozzle of the EI source and heating a section of the nozzle nearest the downstream end of it to provide a temperature for TAPF. Thus, the fragmentation zone is provided within the nozzle of the EI source.

In some embodiments, the thermal fragmentation zone may be arranged within an RF-only ion guide (RFIG). The millisecond timescale (e.g. 0.1-5 ms) heating time would be sufficient for fragmentation at gas pressures in the RFIG above 100 mbar (providing thousands of ion to gas collisions). In some embodiments, the thermal fragmentation zone may be arranged within an RFIG at 0.1-100, 0.1-10, 1-10 or 1-100 mbar, if the ions are trapped axially (i.e. along the long axis of the RFIG) for residence times of 10 ms or greater, or 20 ms or greater, or 50 ms or greater, for example 10-100 ms, or greater than 10 ms to 100 ms. This timescale may be compatible with trapping ions in an RFIG prior to ejecting the ions for analytical purposes into an electrostatic trap mass analyser, such as an Orbitrap mass analyser.

In a yet further aspect, the invention may provide a method of mass spectrometry comprising:
generating molecular ions using an ion source, preferably at a pressure of 0.01 mbar or above, or 0.1 mbar or above, or 1 mbar or above, or 10 mbar or above, preferably 50 mbar or above, especially atmospheric pressure;
introducing at least some of the molecular ions into a fragmentation zone arranged within an RF-only ion guide and trapping the ions axially in the RFIG, wherein the temperature in the fragmentation zone is above 200° C. (or preferably above 300° C., or above 400° C. or above 500° C.) and is filled with a gas at a pressure of 0.1-100 or 0.1-10 or 1-100 mbar or preferably 1-10 mbar;
fragmenting at least some of the molecular ions in the fragmentation zone to form sub-molecular fragment ions;
ejecting the ions from the RF-only ion guide to a mass analyser; and
recording a mass spectrum of the molecular ions and/or fragment ions using the mass analyser.

Accordingly, the invention also provides a mass spectrometer comprising:
an ion source for generating molecular ions, preferably at a pressure of 0.01 mbar or above, or 0.1 mbar or above, or 1 mbar or above, or 10 mbar or above, preferably 50 mbar or above, especially atmospheric pressure;
a fragmentation zone arranged within an RF-only ion guide for receiving at least some of the molecular ions and trapping the ions axially therein, wherein the temperature in the fragmentation zone is above 200° C. (or preferably above 300° C., or above 400° C. or above 500° C.) and is filled with a gas at a pressure of 0.1-100 or 0.1-10 or 1-100 mbar, preferably 1-10 mbar for fragmenting at least some of the molecular ions in the fragmentation zone to form sub-molecular fragment ions;
a mass analyser for receiving ions ejected from the RF-only ion guide and recording a mass spectrum of the molecular ions and/or fragment ions.

Increased residence times can enable a reduction in the fragmentation temperature (to achieve a given degree of fragmentation). The effect is known from infrared photodissociation (IR PD) studies (see P. D. Schnier, W. D. Price, E. F. Strittmatter, and E. R. Williams, Dissociation Energetics and Mechanisms of Leucine Enkephalin (M+H)+ and (2M+X)+Ions (X═H, Li, Na, K, and Rb) Measured by Blackbody Infrared Radiative Dissociation, J Am Soc Mass Spectrom 1997, 8, 771-780; and W. D. Price and E. R. Williams, Activation of Peptide Ions by Blackbody Radiation: Factors That Lead to Dissociation Kinetics in the Rapid Energy Exchange Limit, J Phys Chem A. 1997 Nov. 20; 101 (47): 8844-8852.

In general, fragmentation of ions at atmospheric or high (at or above 50 mbar) pressure by heating gas alone is not evident from the prior art. For instance, hot capillaries and heated interface components have been widely used in electrospray ion sources for soft and non-destructive ion transfer, which discourages use of heating gas for ion fragmentation. This can be explained by the short interaction time between the gas flow and capillaries as well as insufficiently high temperatures compared to the present invention.

According to embodiments of the present invention, a much higher specificity of analysis and better detection limits, especially at atmospheric pressure, can be obtained by combining the selection of an ionized sample molecule on the basis of its ion mobility with measurement of ion mobility of a set of its structure-related fragments (sub-molecular fragments), preferably a set of two or more such fragments. The latter can be obtained preferably by a non-ionizing fragmentation method, most preferably by thermal fragmentation in a stream of hot gas. Embodiments of the invention enable creating multiple reaction monitoring (MRM) or selected reaction monitoring (SRM) methods, with a flexible choice of fragments for better analysing the sample independently of the matrix composition.

The present invention is based on a scheme of tandem ion mobility separation, which enables increased selectivity of ion mobility separation (IMS) at high pressures above 50 mbar and especially at atmospheric pressure. The invention provides increased selectivity through two stages of ion mobility separation. The use of a first stage of IMS greatly simplifies the interpretation of the fragment ion mobility spectra obtained in the second stage of IMS. The fragment ions detected in the second stage IMS can be more reliably assigned to particular parent molecular ions separated in the first stage.

Some preferred embodiments include tandem IMS (wherein each IMS stage comprises one of: FAIMS, gated IMS, or DMA) with thermal atmospheric pressure fragmentation in-between for higher analysis specificity, potentially matching MS specificity in an atmospheric pressure device. For example, for two stages of IMS each having modest resolution of 50, the selectivity is given by a resolution of 50×50=2500. Selectivity in the case of performing multiple channel (MRM) can be much higher.

The invention is particularly well implemented using rapid ion heating in a gas at millisecond time scales (e.g. 0.1-5 ms) at gas temperatures preferably in the range from 300 (preferably above 300) to 700° C. and at atmospheric pressure. This may be termed Thermal Atmospheric Pressure Fragmentation (TAPF). This fast fragmentation is compatible with the time scale of analytical mass spectrometry (e.g. LC-MS or GC-MS). The fast fragmentation also allows efficient ion transmission without significant divergence of the ion cloud by space charge.

Advantages of the hot gas thermal fragmentation or TAPF include production of intense CID-type fragments under relatively high pressure, including atmospheric pressure. The invention is therefore able to produce a high intensity or abundance of fragment ions unlike fragmentation processes that rely on ECD or ETD-like mechanisms. In some embodiments, the invention can produce CID type fragments (e.g, wherein for peptide ions most fragment ions are either a-, b- or y-ions) with a minor proportion of (or substantially no) fragments being ECD or ETD type fragments (e.g. for peptide ions a minor proportion of (or substantially no) fragments are either c- or z-ions). The present invention provides ways of identifying compounds not only on the basis of their molecular ion mobility but also on the basis of their structure-related fragments. The invention is compatible with ion mobility separation operating at atmospheric pressures, e.g. without any vacuum applied to the ion separation and/or fragmentation stages. Some embodiments of the invention also work at pressures of at least 50 mbar.

An advantage of the method is that it appears to be reproducible between instruments and for this reason potentially allows constructing a database for reliable compound identification, e.g. in LC-IMS-IMS and LC-IMS-MS.

The preferred method of thermal fragmentation may also be used with mass spectrometry, i.e. separation of molecular ions and/or fragment ions based on their mass-to-charge ratio (m/z).

Due to the lower costs associated with not requiring high vacuum pumps, embodiments of the invention can provide a low cost analyser, particularly for use with LC or GC chromatographic separations.

### BRIEF DESCRIPTION OF THE DRAWINGS

FIG. 1 shows schematically an embodiment using dual stage DMA.

FIG. 2 shows schematically an embodiment utilising thermal atmospheric pressure fragmentation using an open gas jet.

FIG. 3 shows schematically an embodiment utilising thermal atmospheric pressure fragmentation in a heated channel.

FIG. 4 shows schematically a heating device for producing a heated gas jet.

FIG. 5 shows experimental data obtained on fragmenting peptide ions (neurotensin) by adding products of negative corona discharge.

FIG. 6 shows experimental results of thermal fragmentation of neurotensin.

FIG. 7 shows a thermal fragmentation mass spectrum of neurotensin.

FIG. 8 shows a mass spectrum of the thermal fragmentation of the peptide Leucine-Enkephalin (Leu-Enk).

FIG. 9 shows the dynamics of fragment formation with temperature of the peptide Leu-Enk.

FIG. 10 shows plots of the total fragment intensity and the parent intensity normalized to their sum for thermal fragmentation of the peptide Leu-Enk.

FIG. 11 shows schematically an atmospheric pressure embodiment of dual IMS comprising closed-loop recycling of gas between a first IMS and second IMS.

FIG. 12 shows schematically a reduced pressure embodiment of dual IMS comprising closed-loop recycling of gas between a first IMS and second IMS.

FIG. 13 shows schematically an embodiment of an ion mobility spectrometer using a pulsed ion source, first IMS drift tube with ion gating, thermal fragmentation and second IMS drift tube.

### DETAILED DESCRIPTION

In order to enable a more detailed understanding of the invention, various embodiments and examples will now be described.

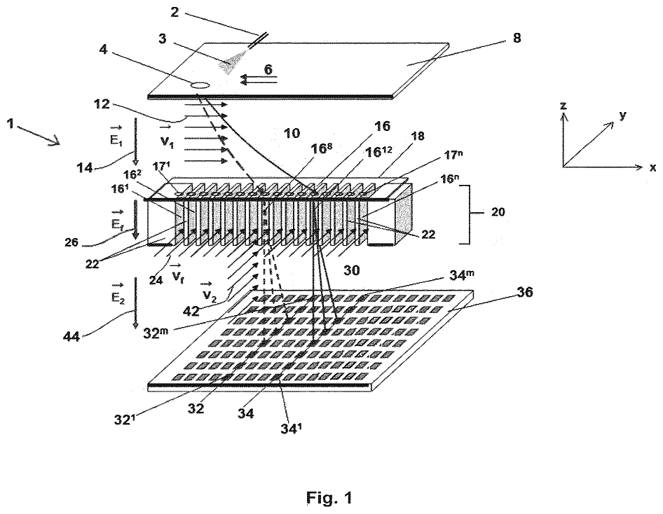

Referring to FIG. 1, there is shown schematically one preferred embodiment of the present invention. As will become apparent, in this embodiment, there is provided a parallel analysis of molecular ions and their fragments ions, in which the ions are separated by a continuous two stage differential mobility analyser (DMA) and detected by a two-dimensional (2D) detector array.

A sample (not shown) is introduced into an ion source 2 of an ion mobility spectrometer 1, in this embodiment a multi-stage ion mobility analyzer. The sample contains one or more components in the form of molecules of one or more different chemical structure. Molecular ions are formed in the ion source from the molecules. In some embodiments, the sample has been subjected to liquid or gas chromatographic separation prior to introduction into the ion source.

As the molecular ions are formed by the ion source 2 (e.g. formed as an ion spray 3 by an electrospray or atmospheric-pressure chemical ionization (APCI), or other ion source, as known in the art), they traverse the ion source chamber 5 and are pushed towards an entrance or sampling aperture 4 of the first ion mobility analyzer 10, for example by a voltage and/or gas flow. The entrance aperture 4 is located in a shield 8, such as a plate. This may be a voltage on the ion source (such as a voltage on the sprayer of an ESI, APCI source). It is preferable to improve desolvation of the molecular ions by using a heated (e.g. 200-500° C.) desolvation gas (e.g. in a curtain or orthogonal flow as shown by gas flow 6). A typically desolvation gas is nitrogen (preferably dry nitrogen) or dry air, with a typical flow rate of 10 L/min. The gas flow may move the ions towards the sampling aperture 4.

The ions preferably enter the sampling aperture 4 at an angle to the plane of the aperture, i.e. to the plane of the shield 8. The angle is generally less than 90 degrees, for example 60 degrees or less, more preferably 45 degrees or less, e.g. 30 degrees or less. It is preferred to sample the ions through the aperture using primarily an electric field rather than a gas flow field.

The first ion mobility analyzer 10 is a differential mobility analyser (DMA). Once molecular ions from the ion source 2 enter the first ion mobility analyzer 10 via the aperture 4 for separation they are picked up by a gas flow field V₁, which has a direction shown by arrows 12 (which is along axis x of the three dimensional axes x, y, z). In this embodiment, the gas flow field V₁ is at atmospheric pressure and is transverse to the direction in which the ions enter the DMA. The gas V₁ is typically not heated, at least not heated enough to cause any fragmentation of the molecular ions, e.g. less than 200° C. Perpendicular to the gas flow field V₁ is provided an electric field E₁, the direction of which is shown by arrow 14 (which is along axis z of the three dimensional axes x, y, z). The molecular ions are thereby spatially separated in the drift space of the DMA according to their ion mobility in the crossed electric E₁ and gas flow V₁ fields. Ions species of different mobilities thus arrive at different parts of the array of fragmentation channels 16, each molecular ion species of a particular ion mobility arriving at its own channel. In total there are n fragmentation channels (16¹, 16², . . . 16ⁿ) in the array 16. At the entrance to the array of fragmentation channels 16 is a multi-apertured plate 18 having n apertures denoted 17¹, 17², . . . 17ⁿ. Thus, each n^{th} fragmentation channel of the array of fragmentation channels 16 has its own respective entrance aperture. The field E is created between shield 8 and the array 16 (e.g. with voltages applied to shield 8 and to multi-apertured plate 18 below it). In some embodiments, to confine the electric field, printed-circuit boards on each side of each gap (drift space) could be used. In some embodiments, the gas flow field could be made more uniform using, for example, grids as known in the art.

The different channels thus receive different molecular ions based on their ion mobility in the first stage of ion mobility separation 10. The resolution of the mobility selection is determined by the size of the apertures 17 and the amount of diffusion in the DMA 10. The fragmentation channels 16 form a fragmentation zone 20. The individual channels 16¹, 16², . . . 16ⁿ are provided between walls 22 that separate adjacent channels. In the shown embodiment, the walls 22 are planar. The channels are thereby also planar. The walls may be made, for example, from material, such as resistive glass or ceramics or SiC, that can be heated and/or the walls can comprise resistive coatings and inks used in resistor technology, etc. The walls can be heated by a heater (not shown). The walls may be heated by a resistive heater, ceramic heater or cartridge heater for example. The heater may be placed in contact with the walls for this purpose. In some alternative embodiments, the multiple fragmentation channels could be provided as respective tubes or capillaries for example, which may have a circular or rectangular cross-sectional profile. These may also be made, for example, from material, such as resistive glass or ceramics or SiC, that can be heated and/or the walls can comprise resistive coatings and inks used in resistor technology, etc.

Each of the selected molecular ion species then transverse the fragmentation zone 20 through their respective fragmentation channel under the force of an electric field E_{f}, the direction of which is shown by arrow 26 (which is, like E₁, along axis z), while they are subjected to heating by a flow of heated gas at atmospheric pressure and a temperature in the range of 400-700° C. In this embodiment, the electric field Ef is applied by a voltage difference between the multi-apertured plate 18 at the fragmentation zone entrance and the bottom of the fragmentation channels 16, the channels 16 being made from resistive material to sustain the field. In pushing the ions through the fragmentation channels by the electric field formed using the resistive channels, it can be possible to keep the ion residence time fixed per molecular species (depending on the ion mobility). This arrangement of electric driving field is preferred to an alternative use of a gas flow Vz in z direction for ion transfer through channels, as Pouseille profiles of Vz(xy) could spread the residence time widely, and if boundary layers do not merge and profiles are not formed, then the flow core may not be sufficiently heated by walls. Another preferred alternative embodiment comprises using a gas flow Vz in the z direction, especially using capillaries as fragmentation channels, using pre-heating of the gas (as described further below).

The heated gas flow in the embodiment shown in FIG. 1 is represented by gas flow field V_{f}, which has a flow direction shown by arrows 24 (which is along axis y). In the fragmentation zone 20, the gas flow field V_{f} is perpendicular (or crossed) with respect to the electric field Ef. Furthermore, the gas flow field V_{f} in the fragmentation zone is perpendicular to the gas flow field V₁ in the first DMA 10. Thus, although the gas flow field V₁ and the gas flow field V_{f} are both in the x-y plane, V₁ is in the x direction while V_{f} is in the y direction. The heated gas may be provided by heating the walls of the fragmentation channels, as described above, to heat the gas flow field V_{f} inside the channels. As an alternative to heating the walls of the channels, the channels may be provided with gas flow field V_{f} that has been already heated by a separate heater before it enters the channels. The heated gas flow V_{f} may be provided as one or more open or free jets of heated gas, such as multiple open jets (e.g. one for each channel). Examples of heated open gas jets are described in other embodiments below. The ion transfer through heated channels or tubes is conveniently compatible with the shown IMS-IMS scheme.

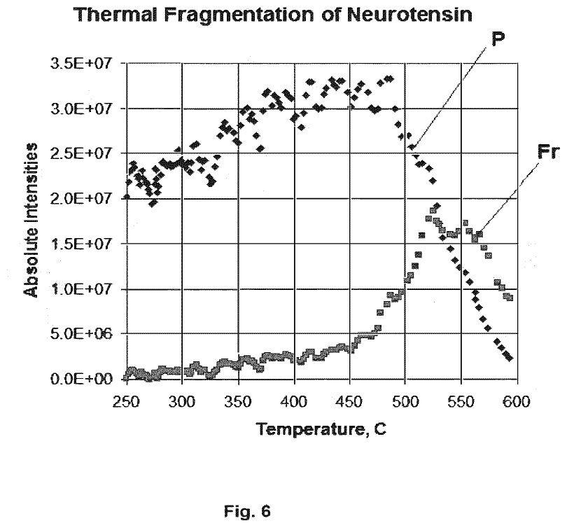

In other embodiments, a lower temperature may be usable for the heated gas flow, for example at least 200° C. (e.g. such as 200-400° C. or 200-300° C.). or at least (preferably above) 300° C. (e.g. such as 300-400° C.). Preferably though the temperatures is at least 400° C., or at least 450° C., or at least 500° C. The temperature may be up to 1200° C., or up to 1100° C., or up to 1000° C., or up to 900° C., or up to 800° C., or up to 700° C. More preferred for fragmentation is a gas temperature of at least (preferably above) 300° C. and better still at least (preferably above) 400° C. or 450° C. or 500° C. The temperature may preferably lie in the range 300-900° C., or more preferably 400-700° C., especially 400-600° C. or 500-700° C. As described below with reference to FIG. 6, the temperature choice can depend on the class of analyzed compounds and on the heating residence time.

In various embodiments of the invention, the gas temperature may be measured directly or indirectly using a temperature measuring device, e.g. a thermocouple located in or adjacent to the fragmentation zone. In some embodiments, a controller connected to a power supply can adjust the power provided by the supply to the gas heating means based on a temperature provided to it by the temperature measuring device. In this way, the gas temperature may be controlled by the controller, e.g. to maintain a target gas temperature that is preferably optimised for fragmentation of the molecular ions. The controller may comprise a computer and/or electronics for this purpose. The target gas temperature can be optimised for fragmentation of the particular sample being analysed (i.e. the molecular ions thereof). The target gas temperature may be predetermined, e.g. according to software or firmware operating the controller, or may be input by a user, such as via a user interface of the controller.

The transit time through the fragmentation zone (i.e. the ion residence time in the zone) can be defined, for example, by the length of the zone, the speed of the heated gas and/or the electric field Er transporting the ions. Preferably, E_{f}>E₁ for improving capture of ions into a channel. The transit time through the channel (equivalent to residence time in the heated gas) is arranged to lie in the range of 0.1-5 millisecond (ms). More preferably is arranged to lie in the range of 0.5 ms-5 ms or 1 ms-5 ms. Residence time preferably should be at least 0.1-1 ms (at least 0.1 ms, at least 0.5 ms, or at least 1 ms), for ions of m/z in a range 400-700. On average, fragmentation rate roughly doubles per 15 C per each individual compound. Especially preferred is a residence time in the heated gas of at least 1 ms.

As the molecular ions travel through the heated gas flow in the fragmentation zone 20, in their respective fragmentation channel, at least some of the molecular ions fragment to produce sub-molecular fragment ions that are related to the structure of the molecular ion (i.e. a subunit thereof). As fragment ions are formed, they, along with any unfragmented molecular ions, reach the second ion mobility analyzer 30, which, like the first ion mobility analyser 10, is a differential mobility analyser (DMA). The gas used for the heated gas flow field V_{f} in the fragmentation zone may be same or different to the gas used in the gas flow fields V₁ and V₂ in the first and second ion mobility separators 10 and 30. Preferably, it is the same gas for V_{f}, V₁ and V₂. The gas or gases for flows V_{f}, V₁ and V₂ may be selected from inert gases such as nitrogen or argon or helium. Nitrogen is a preferred gas. The gas is preferably dried and optionally purified.

The second ion mobility analyzer 30 separates the fragment ions and any unfragmented molecular ions in space based on their ion mobility and they are detected by an array of individual detectors 36 for each fragmentation channel. The ions enter the second ion mobility analyzer 30 after exiting the fragmentation channels of the fragmentation zone. As mentioned, the second ion mobility analyzer 30 is a DMA, wherein the ions are picked up by a gas flow field V₂, which has a direction shown by arrows 42 (which is, like gas flow field V₁ in the fragmentation zone, directed along axis y). In this embodiment, the gas flow field V₂ is again at atmospheric pressure. The gas V₂ is typically not heated, at least not heat enough to cause any further fragmentation of the ions, e.g. less than 100° C. Perpendicular to the gas flow field V₂ is provided an electric field E₂, the direction of which is shown by arrow 44 (which is, like electric fields E₁ and E_{f}, along axis z) to move the ions in the z direction through the second DMA 30 the towards a detector 36. Preferably, E₂>E_{f} for improving transfer of the ions into the second stage DMA 30. The molecular and fragment ions are thereby spatially separated in the drift space of the second DMA according to their ion mobility in the crossed electric E₂ and gas flow V₂ fields in the DMA 30. Particular parameters of field strengths E₁, E_{f} and E₂, and gas flow speeds for V₁, V₁ and V₂ etc. will depend on the required resolving power as known in the art. As an example, a typical length of each separation channel is in the range 10-100 mm or 20-50 mm, gas speed is in the range 10-100 m/s, and field strengths E₁ and E₂ are in the range 2×10⁴-1×10⁵ V/m.

Furthermore, the gas flow field V₂ in the second DMA 30 is perpendicular to the gas flow field V₁ in the first DMA 10. Thus, although the gas flow field V₁ and the gas flow field V₂ are both in the x-y plane, V₁ is in the x direction while V₂ is in the y direction. The gas flow fields V₁ and V₂ may be the same gas flow field, i.e. a single gas flow field, thus comprising the same gas flowing in the same direction. The single gas flow field for may be heated specifically within the fragmentation zone by heated walls of the fragmentation channels.

As shown, for example, in the second DMA 30 the fragment ions from the eighth fragmentation channel 16⁸ become separated from each other (and from any molecular ions) in the y direction and are detected by a one-dimensional array of individual detectors 32¹-32^{m} (i.e. m detectors positioned in a row 32 shown in the y direction). Similarly, in the second DMA 30 the fragment ions from the twelfth fragmentation channel 1612 become separated from each other (and from any molecular ions) in the y direction and are detected by a one-dimensional array of detectors (i.e. in a row 34 shown in the y direction). There are n rows (n 1D arrays) of detectors corresponding to the n fragmentation channels. Thus, a 2D array 36 of n×m detectors is provided. In some embodiments, the individual detectors may be arranged at regularly spaced locations in the 2D array (in x and/or y). In some other embodiments, the individual detectors may be arranged in a 2D array not at regular spaced locations but at specific locations only, e.g. the individual detectors may be provided in locations so as to detect only a limited number of molecular ions and, for each detected molecular ion, one or more fragment ions. The latter may be a more dedicated (molecule-specific) detector than a universal (broad range) detector.

In one embodiment, the detector array comprises a set of ion collectors connected to one or more electrometers. The collectors can be arranged to accumulate charge for sequential reading by a single electrometer. To enhance detector sensitivity, the ions can be field accelerated in front of the detector. The detector or detectors may comprise MCPs or electron multipliers, e.g. an array thereof. The detectors may comprise photodetectors, such as an array photomultiplier tube (PMT) or diode array. In one embodiment, the ions can be field accelerated to sharp tips to produce a photo signal, which is read by a photodetector such as an array photomultiplier tube (PMT) or diode array. The latter may be more practical at fore-vacuum gas pressures produced by a mechanical pump (e.g. rotary or roots pump) in case of single channel detection, or when operating IMS at sub-atmospheric pressures. Even at reduced efficiencies of producing photons, ion counting with a PMT may be much more sensitive than the collector current measurements.

The detector array 36 is connected to a data processing device (not shown) for producing a spectrum of the fragments from data provided by the detector. The data processing device also comprises an instrument interface to operate the spectrometer 1.

Although the embodiment in FIG. 1 has been described as having each of the ion source chamber 5, first ion mobility separator 10, fragmentation zone 20 and second ion mobility separator 30 at atmospheric pressure, in some other embodiments the first or sampling aperture 4 may separate an atmospheric pressure ion source (such as ESI or APCI) and a fore-vacuum stage e.g. at 0.1-100 mbar, or 1-100 mbar, or 0.1-10 mbar, or 1-10 mbar. The fore-vacuum pressure may be produced by a mechanical pump (e.g. rotary or roots pump). In such embodiments, the first ion mobility separator 10, fragmentation zone 20 and second ion mobility separator 30 may be provided at the fore-vacuum pressure. In some embodiments, the operation at fore-vacuum gas pressures may have some advantages such as: lower gas consumption and lower power of gas compressors; induction of gas flows by pumps; non compromised mobility resolution, where lower pressure P is compensated by a linearly scaled dimension of mobility separation L at the same voltage U (defining mobility resolution) in turn, being limited by L/P product; and possibly easier to manufacture devices of larger size.

Although, parallel detection of multiple fragment ions for multiple precursor (molecular) ions is described with reference to FIG. 1 and requires a 2D detector, a simpler design would involve just one selection (fragmentation) channel with different ion mobility molecular ions being sequentially directed to it by the first DMA by changing electric field E₁ and/or gas flow field V₁ (preferably by changing electric field E₁ as it is easier to change the electric field in a controlled way). For each molecular ion being fragmented in the single fragmentation channel in sequence the fragment ions may be separated from each other and detected by a one-dimensional (1D) array of individual detectors. In another, similar embodiment, just one selection (fragmentation) channel may be provided with different ion mobility molecular ions being sequentially directed to it by the first DMA and a single detector provided with different ion mobility fragment ions being sequentially directed to it (for each molecular ion) by the second DMA by changing electric field E₂ and/or gas flow field V₂ (preferably by changing electric field E₂ as it is easier to change the electric field in a controlled way). In a further, similar embodiment, multiple (fragmentation) channels may be provided with different ion mobility molecular ions being directed to it in parallel by the first DMA as shown in FIG. 1 and a single detector provided for each fragmentation channel (i.e. a 1D array of detectors spaced in the same direction as the fragmentation) channels, wherein different ion mobility fragment ions for each molecular ion/fragmentation channel are sequentially directed to a detector for that molecular ion/channel by the second DMA. Thus, individual detection channels, rather than the detection array of FIG. 1, may be used for target analyses. Such target analyzers may have some advantages such as lower gas consumptions due to using fewer separation channels; lower operation cost at fewer detection channels; and selecting fragmentation temperatures for efficiency, since it can be difficult in some cases to fragment all species with the highest efficiency using a single temperature setting.

The fragmentation zone may comprise: an open jet of heated gas, a flame, or a heated channel, tube or capillary.

In some embodiments, the fragmentation zone may be provided, for example, in the form of an open or free jet, e.g. a region containing one or more jets of pre-heated gas (thus passing the sample molecular ions through one or more jets (beams) of heated gas). The term free gas jet or open gas jet herein refers to a stream of gas that is projected into the fragmentation zone, generally from a nozzle or aperture. The free gas jet typically has a higher momentum compared to the surrounding gas. In a gas jet fragmentation, at atmospheric pressures, the gas flow velocity in the jet may be, for example, 0.5-100 m/s, or 0.5-50 m/s, or 0.5-10 m/s, preferably 1-10 m/s, e.g. 2, 3, 4, 5, 6, 7, 8 or 9 m/s. At sub-atmospheric pressures, vacuum pumping may produce gas jets at nearly sonic velocities, e.g. up to 300 m/s for nitrogen, or even supersonic velocities. The gas jet may also be constrained in a channel. In such cases, the channel itself preferably needs to be heated to enable the required gas temperature and therefore fragmentation in the channel.

In other embodiments, the fragmentation zone may be provided, for example, in the form of a heated channel, heated tube or heated capillary. It may be provided, for example, in the form of enclosed channels (e.g. tube-like or flute-like enclosed channels with sampling apertures) through which the sample ions and gas flows, or capillaries through which the ions and gas pass (including a direct current heated capillary), or flames through which the ions pass. The heated channel, tube or capillary may be heated, e.g. from the outside, thereby to heat the gas flowing inside. The heated channel, tube or capillary may comprise a heater inside, e.g. a wire or filament heater, thereby to heat the gas flowing inside. The channel, tube or capillary may receive a gas that has been pre-heated before entry into the channel, tube or capillary.

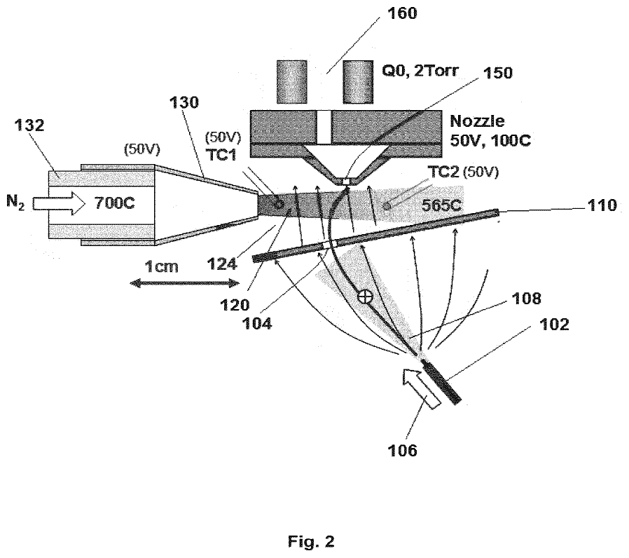

An example of an embodiment utilising thermal atmospheric pressure fragmentation in open jet is shown schematically in FIG. 2. An atmospheric pressure ion spray source 102 at 3 kV sprays a cloud of positive molecular ions 108 towards a shield 110 held at 0-1 kV. A gas flow 106 such as nitrogen at 2 L/min assists with transporting and/or desolvating the ions. The molecular ions are sampled through an aperture 104 in the shield. The molecular ions then travel through a fragmentation zone provided by an atmospheric pressure free jet 120 of heated nitrogen gas emitted from a nozzle 130. The free jet 120 has a higher momentum compared to the surrounding gas 124. The free jet is directed substantially transverse to the direction of ion travel. Temperature measuring devices in the form of thermocouples TC1 and TC2 measure the gas temperature. The gas jet temperature is approximately 565° C. where the thermocouple readings differ, an average may be taken as the gas temperature. Typically, a spread or range of gas temperatures in the fragmentation zone is less than 30° C. or less than 20° C., for example achieved by ion sampling primarily with electric field and by reducing the sampling of the relatively colder gas of flow 106 through the aperture 104. The gas jet 120 is generated by a flow of nitrogen at 2 L/min through a heated tube 132 wherein the gas temperature is approximately 700° C. before it leaves the tube. The estimated heating time is about 1-2 ms, based on a 3 m/s average jet velocity. The capillary 132 is a resistively heated quartz tube. The molecular ions fragment into sub-molecular fragments in the heated free gas jet and the fragment ions then enter an RF only transfer quadrupole 160 of a mass analyser at 2 torr through a nozzle 150, which is held at a lower potential (50V). The ions are analysed by their mass-to-charge ratio (M/z) in the mass analyser. The use of open or free jets has been found to provide very reproducible fragmentation of ions. Furthermore, good transmission of ions can be obtained by fragmenting using open jets.

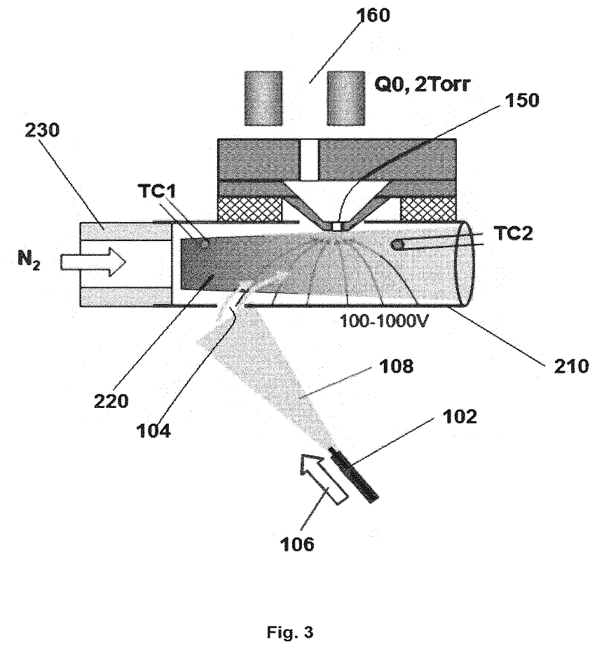

An embodiment utilising thermal atmospheric pressure fragmentation in a heated channel is shown schematically in FIG. 3. The embodiment of

FIG. 3 shares numerous similar components to the embodiment of FIG. 2 so like components are given like reference numerals. An atmospheric pressure ion spray source 102 at 3 kV sprays a cloud of positive molecular ions 108 towards a tube or flute (denoting tube with sampling aperture) 210 held at 100-1000 V. A gas flow 106 such as nitrogen at 2 L/min assists with transporting and/or desolvating the ions as they flow towards an entrance or sampling aperture 104 in the tube 210. The molecular ions are sampled through the aperture 104 in the tube. The molecular ions then travel through the tube in an atmospheric pressure flow 220 of heated nitrogen gas (0.5-10 L/min) emitted from a heated capillary 230, which forms a fragmentation zone. The capillary 230 is a resistively heated quartz tube. The gas flow is directed transverse to the direction of ion travel as the ions enter the tube. Temperature measuring devices in the form of thermocouples TC1 and TC2 measure the gas temperature. The heating time of the ions (i.e. the residence time of the ions in the gas flow) can be controlled by the gas flow rate in the tube. The molecular ions fragment into sub-molecular fragments in the heated gas flow and the fragment ions then enter an RF only quadrupole 160 of a mass analyser at 2 torr through a nozzle 150 located in an exit aperture of the tube. The ions are analysed by their mass-to-charge ratio (M/z) in the mass analyser.

Variants of the embodiments of FIG. 2 or FIG. 3 preferably could be implemented with a stage of ion mobility separation, such as a first DMA as shown in FIG. 1, between the ion source and the entrance to the fragmentation zone. In such embodiments, different ion mobility molecular ions could be sequentially directed to it by the first DMA, i.e. by changing an electric field and/or gas flow field (preferably by changing an electric field) in the DMA. For each molecular ion then fragmented in sequence, the fragment ions could be analysed by their mass-to-charge ratio (M/z) in the mass analyser.

The invention can therefore be implemented using a number of different designs for providing a heated fragmentation zone: free jet, tube or flute-type enclosed channels, heated capillaries, including direct current heated capillaries, examples including tantalum (Ta) or tungsten (W) capillaries or tubes, Kanthal™, Nicrothal™ (FeCrAl, NiCr alloys) or SiC-like semiconductor tubes. Tantalum, Kanthal™, Nicrothal™ are preferred because of their tendency for resistance to oxidation at higher temperatures. Another embodiment may comprise a rolled Ta foil that is directly heated.

Surfaces adjacent the fragmentation zone and/or exposed to the heated gas can be made from, e.g., oxidation-resistant refractory metal, such as tantalum (Ta), or carbides (SiC, WC), or, depending on thermal wall conductance, of stainless steel or tungsten (W). The heating of the gas may be provided by a gas heating means, such as one or more resistive heaters, wire heaters, ceramic heaters, silicon carbide (SiC) heaters, or cartridge heaters, or other heaters, preferably resistant to oxidation and specified for at least 300° C. temperatures by wire insulation). The one or more heaters may comprise one or more heaters located external to a region, channel or tube through which the ions and gas flow, such as to heat the gas through one or more walls adjacent the region, channel or tube. Alternatively, or additionally, the one or more heaters may comprise one or more heaters located internal to a region, channel or tube through which the ions and gas flow, such as a heated wire or filament in the region, channel or tube. An example of one preferred heating arrangement is a resistive heater located around a tube or channel (such as a quartz tube), the gas being passed through tube when the tube is heated by the heater. These may be easily used for gas temperatures up to 700° C. In another embodiment, the gas heating means heats a flow of gas so as to provide a heated gas jet that is directed into the fragmentation zone.

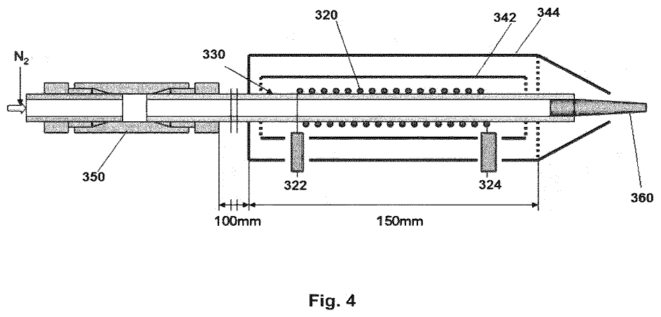

A heating device for producing a heated gas jet is shown schematically in FIG. 4. A quartz tube 330 is provided with a nichrome coil heater 320 wound around its external surface to heat the tube (connections to the heater are shown at 322 and 324 that supply a 30V, 10 A current). Two layers of 0.1 mm stainless steel shield 342, 344 are provided around the tube and heater. Gas, such as nitrogen, is supplied to an inlet of the quartz tube via a Swagelok™ connection 350 to a gas source (not shown). A typical gas flow rate is 3 L/min. A gas flow is heated by the hot tube 330 and emitted from a 4 mm diameter nozzle 360 to form a hot gas jet.

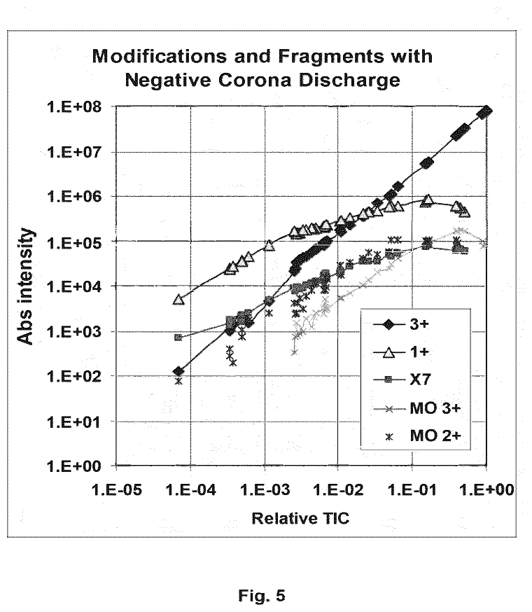

As described in the Background, there are multiple known ways to fragment molecules at atmospheric pressure. For example, FIG. 5 shows experimental data obtained on fragmenting peptide ions (neurotensin with charge states +1, +2 and +3) by adding products of negative corona discharge (n-CD) into a gas flow to fragment the peptide ions, arranged without removing electrospray solvent. In the plot shown, the 3+, 1+ designate charge states of molecular ions; X7 is the X7 fragment of neurotensin, M0 3+″ is the oxide ion of M3H³⁺ and M0 2+″ is the oxide ion of M2H²⁺. The scales are logarithmic. The fragment X7 was observed at 1×10⁻³ relative intensity of the M3+ molecular ion peak. The trends illustrated in FIG. 5 include the drop of absolute signal intensities versus drop of the overall signal intensity, induced by larger n-CD currents or faster delivery of n-CD products. Overall, the primarily observed effects of n-CD, as illustrated in FIG. 5, are: (a) ionization of air impurities, thus, forming additional chemical background, (b) charge reduction of peptide ions with increasing share of lower charged ions; (c) significant drop of the overall intensity; (d) formation of oxide ions, most probably produced by ozone, produced in the n-CD; (e) formation of fragments at low intensity.

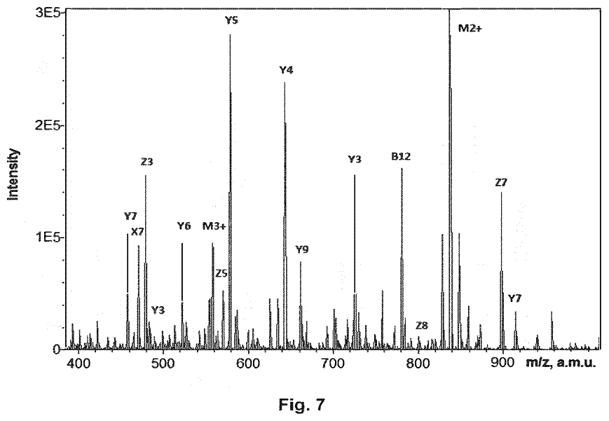

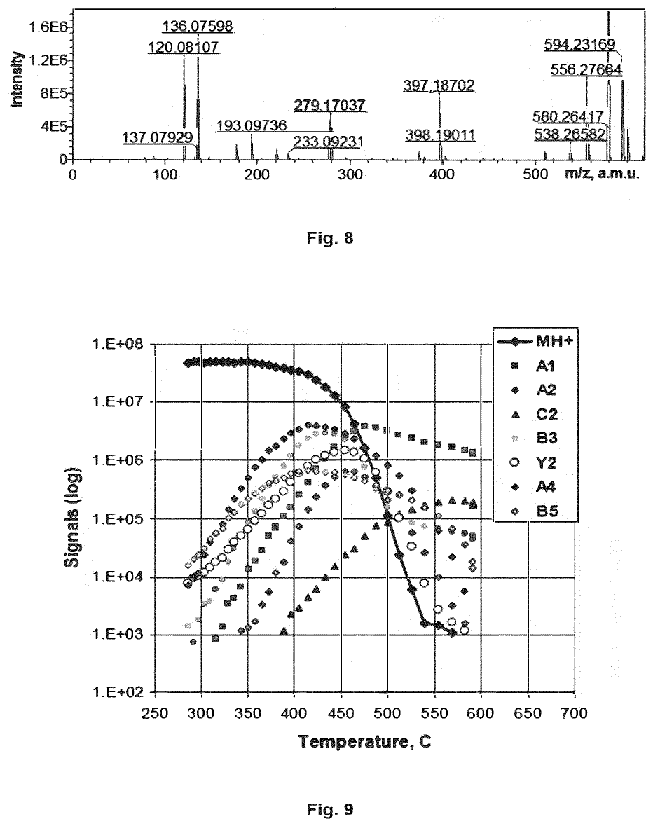

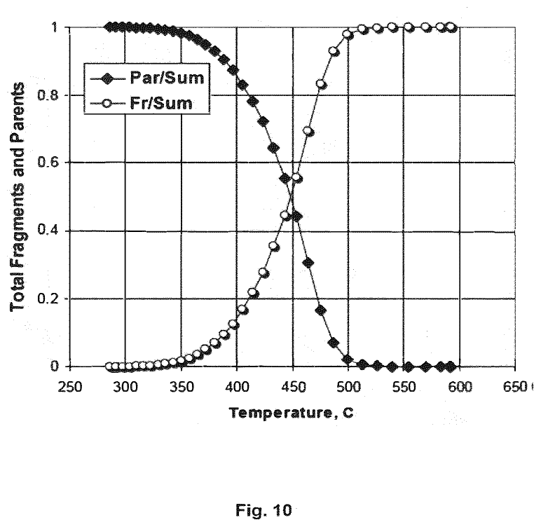

In contrast to n-CD, rather than employing ionizing fragmentation methods, the present invention utilizes a novel method of thermal ion fragmentation at atmospheric pressure or higher pressure vacuum, i.e. fragmentation caused by interacting the sample molecules with a heated gas so as to transfer thermal energy. The thermal ion fragmentation method provided by the invention can: (a) produce an abundant and reproducible ion fragmentation depending solely on the structure of fragmented molecule, gas temperature and optionally the residence time of the molecule in the heated gas; (b) not introduce additional chemical background (ionizing fragmentation methods, for example, may produce a high background of newly formed ions from impurities and background gases, thereby complicating the interpretation of the sample fragment spectra; and (c) not affect the overall signal intensity (e.g. by charge reduction). FIGS. 6 and 7 illustrate this for the same sample, neurotensin. FIG. 6 shows the absolute signal intensity of all precursor ions (P) with 3+, 2+ and 1+ charge states and absolute signal intensity of all fragments (Fr) vs temperature of heated gas flow using the hot gas jet set-up. All scales are linear. Substantial fragmentation is observed at 500-600° C. The optimum fragmentation temperature can depend on the compound type to be fragmented and optionally on the ions' residence time (longer residence times may allow a lower temperature). In our experiments, doubling of residence time does drop the characteristic fragmentation temperature (for 50% degree of fragmentation) by 15-20° C. for about 50 tested compounds of different chemical classes. The effect is known from IR PD studies, where fragmentation occurred at about 200-300° C. at residence times on the scale of minutes. FIG. 7 shows a mass spectrum of neurotensin subjected to thermal fragmentation, which is similar to spectra produced by collisional induced dissociation (CID) in vacuum. The spectrum is composed of y-, b-, x- and z-ions, mainly b- and y-, containing structural information, suitable for library identification of the peptide. FIGS. 8, 9 and 10 show the results of the thermal fragmentation of another peptide sample, Leucine-Enkephalin (Leu-Enk). FIG. 8 shows the mass spectrum of the fragmentation and FIG. 9 shows the dynamics of the fragment formation with temperature. The decrease of the molecular ion MH⁺ particularly above 400° C. is accompanied by the increase in the fragment intensities. The intensity scale is logarithmic. The degree of molecular ion fragmentation may be used as a calibrant or molecular thermometer. As seen in FIG. 9, a fragment ion ratio varies with temperature much slower than the degree of fragmentation. Indeed, the curves for fragment ions stay nearly parallel over a wide temperature range, compared to the curve for fragmentation of the molecular ion. This means that the degree of (molecular ion) fragmentation can serve as a temperature calibrant or thermometer. This can allow adjustment of the fragmentation temperature (and/or residence time) to optimize the sensitivity of the method for target compounds, especially where fast adjustments of the reactor temperature can be achieved, for example by mixing hot and cold gas jets. A ratio of one fragment per parent may be used in the method. One way of measuring the degree of fragmentation is to measure at least one fragment ion and the molecular ion. Another method is to introduce heated gas as a pulse, i.e. detecting molecular ions with and without fragmentation. FIG. 10 plots the total fragments intensity and the parent intensity normalized to their sum. Early thermal fragmentation starts appearing at gas temperatures above 250 C. Notable fragmentation occurs above 350° C. and above 400° C. In some embodiments, the fragmentation temperature can be changed, for example stepped, during the analysis to adjust the fragmentation temperature to be optimal for the target compound(s). This may not be required, for example, if it is a single channel analysis. Such variation of the fragmentation temperature, for example, can be achieved by mixing hot and cold gas at specific calibrated ratios. Stepping the fragmentation zone temperature or residence time is a method of improving selectivity, since a curve of fragmentation degree versus temperature, as shown FIG. 10, depends on the compound.

The thermal fragmentation method generates intense fragments (unlike ECD or ETD). A hot gas allows substantial fragmentation, e.g. a degree of fragmentation (total fragments intensity per total signal) of 90% in some cases occurs above 500° C. . . . Furthermore, the total ion current only slightly drops at higher temperatures, thus, heating does not cause ion discharging. The hot gas method does not produce any new background ions (contrary to ionizing fragmentation methods). Thus, thermal fragmentation can be a useful fragmenting method at atmospheric pressure for the tandem identification of compounds, e.g. in set-ups such as the IMS-IMS systems described herein.

Other known fragmentation methods such as irradiation by photons (e.g. photons of any of the following: vacuum UV, UV, IR or visible) or electrons (e.g. from glow or corona discharge, or from a vacuum tube) or metastable atoms and molecules could be used, e.g. in addition, but it is preferable to use a non-ionizing fragmentation method, i.e. thermal energy only.

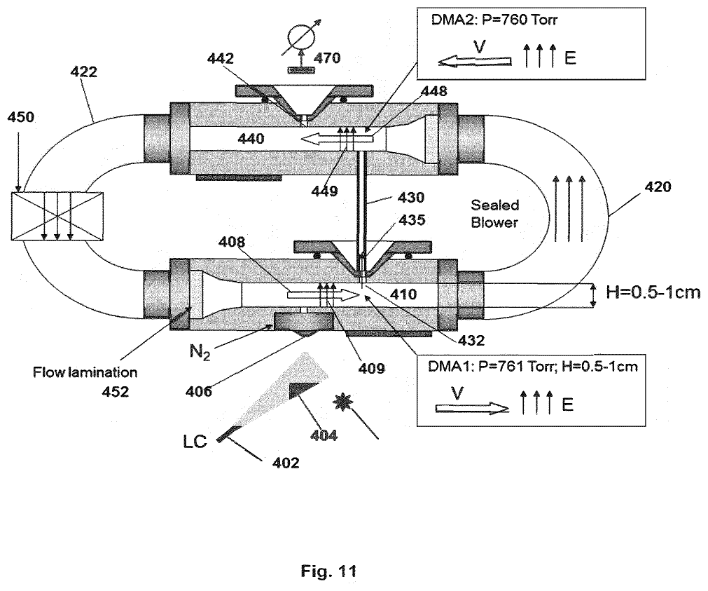

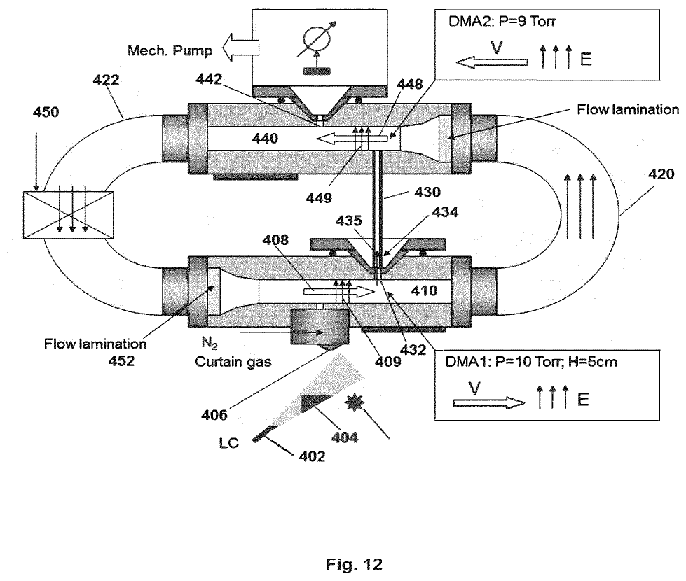

In further embodiments, to preferably reduce consumptions of power and purified gas (or at least dried gas), gas from a first stage of ion mobility separation (e.g. DMA) is re-used for a second stage of ion mobility separation (e.g. DMA), as well as preferably in the fragmentation zone, and then re-cycled back into the first stage by a close-loop compressor. Such an embodiment is shown in FIGS. 11 and 12. FIGS. 11 and 12 are similar but whereas the FIG. 11 shows an atmospheric pressure (1 atm=1 bar) embodiment, FIG. 12 shows a vacuum embodiment (10 mbar). Similar features are given the same reference numerals in each of FIGS. 11 and 12. An LC separation provides sample molecules to an ion source 402. Molecular ions 404 are sprayed under the influence of a voltage on the ion source towards an entrance or sampling aperture 406 of a first stage of ion mobility separation. The ions are desolvated using a curtain gas (N₂) as they travel to the aperture 406. The first stage of ion mobility separation is a first differential mobility analyser DMA (DMA1). The DMA1 contains a flowing gas field (N₂) in the direction indicated by arrow 408. Perpendicular to the gas flow field 408 is provided an electric field in the direction indicated by arrows 409. The ions separate in DMA1 according to their differential mobility in the crossed gas and electric fields and selected molecular ions enter an entrance aperture 432 of a thermal fragmentation channel in the form of a heated capillary 430 (e.g. a capillary made of tantalum, tungsten or other oxidation resistant material, or steel (preferably coated by tantalum, tungsten or other oxidation resistant material)). Molecular ions of different ion mobility may be scanned into the aperture 432 by changing either the electric field 409 or gas velocity 408. The aperture 432 samples the ions by means of gas flow from the DMA1 into the heated capillary 430 in the direction of arrow 435. The capillary is heated for example to heat the gas therein to 400-600° C. as described above. Therein the molecular ions fragment into sub-molecular fragment ions, which are carried by heated gas flow together with any unfragmented molecular ions into a second stage ion mobility analyser in the form of second DMA (DMA2).

The drift space 410 of DMA1 is in fluid communication with a first gas conduit 420 such that the gas field 408 flows gas though the drift space 410 of DMA1 and into the first gas conduit 420. The gas flow direction is indicated by the arrows in gas conduit 420. The gas then flows into drift space 440 of DMA1 in the direction indicated by arrow 448 to provide a gas flow field in DMA2. It is noted that gas flow field 448 of DMA2 is in the opposite direction to the gas flow field 408 in DMA1. Perpendicular to the gas flow field 448 is provided an electric field in the direction indicated by arrows 449. The ions separate in DMA2 according to their differential mobility in the crossed gas and electric fields and selected molecular ions enter an entrance aperture 442 of a detector 470, which can be a simple ion detector or a mass spectrometer. In DMA 2, fragment ions of different ion mobility may be scanned into the aperture 442 of the ion detector by changing the electric field 449.

The drift space 440 of DMA2 is in fluid communication with a second gas conduit 422 such that the gas field 448 flows gas though the drift space 440 of DMA2 and into the second gas conduit 422. The second gas conduit 422 is in fluid communication with drift space 410 of DMA1 such that the gas is thereby re-circulated into DMA1 again. A sealed blower or compressor 450 in second gas conduit 422 drives the gas back into the DMA1 in the circulation loop.

Preferably, metal fan blades (squirrel wheel type or radial rotary type, similar to ones used for industrial hot gas processing, see for example www.chuanfan.com/showroom1.html) of the compressor 450 are remote from a motor to avoid contaminating fumes. Preferably, a mesh and/or dust filter (such as porous metal, also serving as heating means) 452 are used for gas flow laminarisation. Though the IMS spectrometer of FIG. 11 should be more compact at 1 atm pressure, a larger size of gas blower might make the device as bulky, and similar cost as the 10 mbar IMS spectrometer of FIG. 12, where operation at 10 mbar is expected to provide benefits of easier construction and of higher parameters with easily achieved laminar gas flow.

The ion transfer through heated channels or tubes 430 is conveniently compatible with the shown IMS-IMS scheme based on a cycled DMA analyzer. The gas flow scheme may be modified for a gas pressure drop between the IMS stages (which may occur in the cycled gas scheme proposed in FIGS. 11 and 12), e.g, wherein the second IMS stage is lower pressure than the first IMS stage, so that a gas flow is achieved through the fragmentation device that connects the IMS stages, whereby the gas flow samples the molecular ion precursors into the fragmentation device 430 and then into the second stage IMS (DMA2).

The overall specificity of molecular identification is proportional to the multiplication of the ion mobility resolutions of the first stage IMS (resolution R1) and second stage IMS (R2), i.e. R1×R2. Further separation stages could be incorporated in the design for further improvements in this regard. Selection of multiple fragment ions (at least 2 but, preferably, 3-6 characteristic fragments) improves both specificity and confidence of the identification.

In some embodiments, the relative intensity, i.e. abundance, of fragment ions to each other and/or to their parent molecular ion can be used for additional confidence or confirmation of molecular identification, e.g. as known in triple quadrupole mass spectrometry (multiple reaction monitoring method, MRM) or high resolution mass spectrometry (parallel reaction monitoring method, PRM). Such additional confidence is best enabled by reference/comparison of the acquired fragment IMS spectrum to a library of fragments (fragment IMS spectra or MS spectra) that has been created for each of a plurality of analytes of interest. A sufficient match of fragments acquired from the sample to fragments in the library can be used to identify the molecule(s). The library is preferably a library of fragments or fragment spectra that has been acquired using the same type of thermal fragmentation, and preferably IMS separation, as described herein. The library is preferably a library of fragments or fragment spectra that has been acquired using the same type of thermal fragmentation, and preferably IMS separation, as used to acquire the fragment IMS spectrum for the sample. The library preferably also contains fragments (fragment IMS spectra or MS spectra) of one or more calibrants. In this way, samples of interest can be analysed using the invention along with at least one calibrant. The calibrant could be external (i.e. run in another experiment than the sample of interest) or internal (i.e. part of the same mixture as the sample). The main function of calibration would be to use the calibrant(s) as a so-called molecular thermometer to establish optimum effective temperature (and optionally other conditions) of fragmentation, preferably to provide corresponding fragmentation to the calibrant(s) in the library). Thus, K1 and K2n (i.e. the ion mobilities of the parent molecular ions (K1) and each of their n fragment ions (K2ₙ), n is 1, 2 . . . n) can be measured, while the matrix may vary. The method preferably selects those fragments which exhibit the correct intensity ratio, even in the presence of the matrix. A high reproducibility of temperature calibration (e.g. using chemical thermometers as described) of the thermal fragmentation method enables a high reproducibility of fragment ratios and therefore confidence in comparison with a library of fragment ion IMS spectra.

In some embodiments, internal calibrants can also be used for quantitation in targeted analysis, in particular, if they are provided in the form of isotopically labelled variants of analytes of interest. Comparing to mass spectrometry, labelling with ²H (Deuterium) or ¹³C, for example, needs to be more extensive to enable a larger mass difference and therefore larger mobility difference in order to accommodate the generally lower levels of ion mobility resolution (30-200 for each of stages) comparing to even nominal-mass mass spectrometry resolution (200-2000). Preferably, at least 6-15 Da mass shift is to be provided in internal calibrants, or a chemically attached tag is provided for sufficient mobility shift. In case of GC or LC separation, this might result in a significant shift in retention times that needs to be taken into account during quantitation.

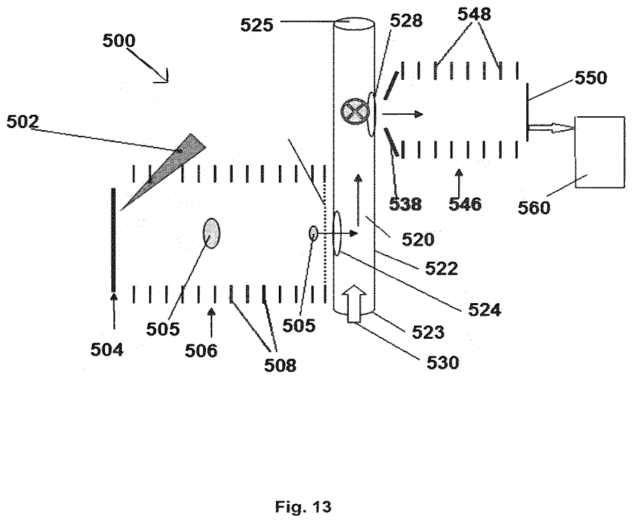

In FIG. 13 another embodiment of an ion mobility spectrometer 500 is schematically shown, wherein a pulsed ion source is used. For a pulsed ion source, a drift tube, preferably a linear drift tube, is desirable. A drift tube is more suitable as it allows selection of one or more species of molecular ions by gating one or more packets of molecular ions of interest, e.g. gating the packet(s) of ions after an appropriate delay from the pulse (i.e. after a first stage of IMS). A pulsed ion gate is thus provided for this purpose. If desired, to improve duty cycle, multiple packets could be selected with an appropriate delay between gating pulses. Temporal broadening of the packet in the fragmentation zone could be reduced by eluting ions out of this zone at lower electric field and then step-wise applying a stronger, spatially inhomogeneous electric field in order to reduce the duration of the peak at the expense of its size.

In detail, FIG. 13 shows a pulsed laser source 502, e.g. for implementing a MALDI source. The laser is arranged to irradiate a sample held on a sample plate 504 at atmospheric pressure and produce a pulse of molecular ions. The pulse of produced molecular ions then enters a first buffer gas-filled ion mobility drift tube 506 wherein the molecular ions 505 of the ion pulse separate based on their ion mobility in an axial DC potential provided by a series of ring electrodes 508 axially spaced apart along the length of the drift tube, as known in the art. The buffer gas is arranged flowing in the opposite direction to the direction of ion travel but that is not necessary. The ions reach the exit of the drift tube at different times dependent on their ion mobility. At the exit of the first drift tube 506 is a Buckbee-Mears ion gate 518 for gating (i.e. selection) of molecular ions. The ion gate is optional. After (optional) gating, the molecular ions enter a fragmentation zone 520 provided inside a fragmentation tube 522. An entrance aperture 524 is provided in the tube for sampling the molecular ions in this way. A hot gas e.g. at 400-700° C. is arranged to flow through the tube in the direction shown by the arrow 530. The tube may be heated for this purpose. The gas flows from an entrance 523 to an exit 525 of the tube. The molecular ions are subject to thermal fragmentation in the fragmentation zone and the produced fragment ions travel in the hot gas flow 530 along the fragmentation tube 522. Ion extraction optics 538 downstream of the fragmentation zone, which may be pulsed, extract the ions from the fragmentation zone via exit aperture 528. The fragment ions, and optionally any unfragmented molecular ions, then enter a second buffer gas-filled ion mobility drift tube 546, wherein the ions separate based on their ion mobility in an axial DC potential provided by a series of ring electrodes 548 axially spaced apart along the length of the drift tube. The buffer gas is arranged flowing in the opposite direction to the direction of ion travel but, again, that is not necessary. The separated ions are finally detected by an ion detector 550, which is connected to a data processing device 560 for producing a spectrum of the fragments. The data processing device also provides control of the spectrometer 500.

Although the FIG. 13 embodiment has been described as an atmospheric pressure system, as described above, the ion mobility stages and fragmentation zone could be maintained at a vacuum, e.g. 1 mbar or above, preferably 50 mbar or above, in that case, preferably, using radiofrequency (RF) fields for radial ion confinement.

In a variation of the embodiment shown in FIG. 13, a travelling DC wave can be applied to the series of ring electrodes 508 of the first ion mobility drift tube to select molecular ions of certain mobility, for example as disclosed in U.S. Pat. No. 5,789,745. Optionally, a travelling DC wave could be applied to the series of ring electrodes 548 of the second ion mobility drift tube to select fragment ions of certain mobility.

In some embodiments, wherein the sample is delivered in a continuous mode, the fragmentation conditions (e.g. gas temperature or power density) could be changed over time in order to construct fragmentation curves (e.g. degree of fragmentation versus temperature), which can be indicative of the analyte structure, i.e. the identity of the molecular ion. When interfaced to a mass spectrometer, such a 1-dimensional (1D) scan could be complemented by a 2^{nd} dimension of scanning fragmentation spectra inside mass spectrometer (e.g. collision energy in collision-induced dissociation, or exposure in infrared or ultra-violet photodissociation, interaction time in electron-transfer dissociation, etc.).

In some embodiments, wherein the sample is delivered in a time-dependent manner (e.g. from a liquid or gas separation, such as LC or GC) and both precursor (molecular ion) and fragment spectra need to be collected, a pulsed operation of the thermal fragmentation can be arranged by using pulsed valves to mix cold and hot gas streams for rapid temperature variations, thereby to effectively switch the fragmentation between on and off, or alternatively using ion optics to electrically steer ions to by-pass the fragmentation zone.

In any of the foregoing embodiments, the ions can be produced by any of the following ion sources: ESI, APCI, APPI, APGC with glow discharge, AP-MALDI, LD, inlet ionization, DESI, LAESI, ICP, LA-ICP, etc. these can be interfaced to any of the following separations: LC, IC, GC, CZE, GC×GC, LC-LC, etc. Multiple ion sources or ionization sprayers or channels could be used in parallel and gated either mechanically or electronically as known in the art. Any type of ion mobility separation can be used as described herein. Any combinations of these units can be used to create analytical instruments with any combination or number of stages of analysis.

A number of preferred embodiments of analytical methods can be implemented according to the invention:
a. Single compound monitoring at nearly unity transmission and at very high speed analysis of a few ms (1-3 ms may be required for monitoring ultra-fast processes, e.g., engine control, or selected reaction monitoring). Such embodiments preferably comprise fixing the fragmentation temperature T, and passing ions at fixed first and second mobilities K1 and K2, to the detector, which we abbreviate as K1, T, K2. The occurrence and intensity of individual target compounds are thereby detected, e.g. as function of an upfront chromatographic separation time (retention time), or the occurrence and intensity of the target compounds in air monitoring with a mobile laboratory can be performed, or similarly in the monitoring of a technological process.
b. Multiple reaction monitoring (MRM) with preselected channels for ultra-trace and/or ultra-fast analysis by switching K1, T and/or K2 for each particular reaction. Preferably, the fragmentation temperature is adjusted between multiple channels of MRM.
c. Increased sensitivity by sampling ions using a mechanical pump, accelerating to a scintillator tip, and then detecting individual ions. Selectivity of dual IMS can be comparable to a single MS (e.g. resolution of 50×50=2500). Selectivity or specificity of detection using multiple channel MRM can be much higher.
d. Parallel 2D analysis of ions, i.e. comprising separating molecular ions in one dimension and their fragments in another, orthogonal direction (for example as illustrated by the embodiment shown in FIG. 1).
e. 2D analysis of ions using thermal scans, where parent ions are separated by their mobility K1 in the first IMS1 stage; the fragmentation temperature T varies in time at slower time scales compared to IMS1 time scale; and the overall intensity of (all or majority of) fragment ions is detected as the function of K1 (mobility) and T (fragmentation temperature) only, thus avoiding slow scanning of three parameters-K1, T and K2. To detect overall fragment intensity, the second mobility filter is time-linked to the first one. In one method, IMS2 passes to the detector only those ions whose K2 is less than K1 (the method is useful for small molecules producing 1+ ions predominantly). In another method, IMS2 forms a notch, to pass all ions with K2 being not equal to K1. This method is more appropriate for large peptides and proteins, where multiply charged fragments may have K2>K1.
f. 3D analysis: IMS1-Th.Scan-IMS2
g. IMS-Th.Frag-MS. This can be implemented, for example, in embodiments where the detector 470 of the system shown in FIG. 11 is a mass spectrometer.
h. IMS-Th.Scan-MS. This too can be implemented, for example, in embodiments where the detector 470 of the system shown in FIG. 11 is a mass spectrometer.
(above Th.Frag means thermal fragmentation and Th.Scan means thermal fragmentation with scanned temperature, i.e. detection of fragments as a function of temperature in the fragmentation device. Generally, fragmentation temperature variations are made on a slower time scale compared to IMS1 separation time)
i. Tracking M-dM patterns for fragments in the case of MS analysis (thus providing a “3D analysis”), becoming 4D with thermal profiles, wherein M refers to the fragment mass and dM is the difference of the mass from the integer mass, i.e. the so-called mass defect. For example, for a homologous series (e.g. polymer series), all compounds of the same series will fall on one line.

Further preferred embodiments include:
j. LC or GC followed by sequential dual stages of DMA for MRM monitoring. In these embodiments, multiple fragment ions can be detected for each molecular ion. It is most preferably implemented using a single channel detector, wherein the ion mobilities of the parent, molecular ions (K1) are mapped over the LC/GC retention time, and ion mobilities of the fragments (K2) are scanned by stepping field strength, preferably stepping the electric field strength of a second DMA.
k. LC-IMS-Thermal Fragmentation-MS, which is particularly useful for compound identification via fragment libraries.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” means “one or more”.

Throughout the description and claims of this specification, the words “comprise”, “including”, “having” and “contain” and variations of the words, for example “comprising” and “comprises” etc, mean “including but not limited to”, and are not intended to (and do not) exclude other components.

The present invention also covers the exact terms, features, values and ranges etc. in case these terms, features, values and ranges etc. are used in conjunction with terms such as about, around, generally, substantially, essentially, at least etc. (e.g., “about 3” shall also cover exactly 3, or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

Any steps described in this specification may be performed in any order or simultaneously unless stated or the context requires otherwise.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

1. A method for mass spectrometry or ion mobility spectrometry, the method comprising:
generating molecular ions from a sample;
transmitting the molecular ions through the fragmentation zone;
adjusting gas conditions within the fragmentation zone in a pulsed manner such that:
at a first time, at least some of the molecular ions are thermally fragmented in the fragmentation zone to form sub-molecular fragment ions using a heated gas, and
at a second time, a cooler gas is mixed with the heated gas to sufficiently reduce the gas temperature such that fragmentation of the molecular ions does not occur; and
detecting at least some of the sub-molecular fragment ions.

2. The method of claim 1, further comprising:
identifying at least one molecular ion based on its mobility characteristics and/or the mobility characteristics of at least one detected fragment ion

3. The method of claim 1, wherein adjusting gas conditions within the fragmentation zone in the pulsed manner occurs at a time scale in a range from 10 to 100 milliseconds.

4. The method of claim 1, wherein adjusting gas conditions within the fragmentation zone in the pulsed manner includes operating one or more pulsed valves for pulsing one or more gas streams.

5. The method of claim 1, wherein the interaction time of molecular ions with the heated gas in the fragmentation zone is in a range from 0.1 to 5 milliseconds.

6. The method of claim 5, wherein the interaction time is at least 2 milliseconds.

7. The method of claim 1, wherein transmitting the molecular ions through the fragmentation zone includes applying an electric field to keep a molecular ion residence time within the fragmentation zone fixed per molecular species.

8. The method of claim 1, wherein the fragmentation zone includes an array of fragmentation channels, the method further comprising:
at the first time, fragmentation is switched on for less than all fragmentation channels in the array of fragmentation channels.

9. The method of claim 1, wherein the fragmentation zone includes an array of fragmentation channels, the method further comprising:
at the first time, fragmentation is switched on for all fragmentation channels in the array of fragmentation channels.

10. The method of claim 1, further comprising:
separating the molecular ions in time using an ion mobility spectrometer (IMS) or using chromatographic separation, wherein adjusting gas conditions within the fragmentation zone in the pulsed manner includes setting the first time and second time such that only selected molecular ions are fragmented.

11. The method of claim 1, wherein generating the molecular ions includes:
spraying molecular ions from an atmospheric pressure ion spray source; and
transporting the molecular ions from the ion spray source towards the fragmentation region using a gas flow.

12. The method of claim 1, further comprising:
determining a degree of molecular ion fragmentation; and
adjusting a fragmentation temperature in the fragmentation zone using the heated gas and cooler gas based on the determined degree of molecular ion fragmentation.

13. A spectrometer, comprising:
an ion source for receiving a sample and generating molecular ions from the sample;
a fragmentation zone for fragmenting at least some of the molecular ions, the fragmentation zone including:
a first gas stream to provide heated gas to thermally fragment the molecular ions to form sub-molecular fragment ions, a second gas stream to provide cooler gas configured to mix with the heated gas to sufficiently reduce the gas temperature such that fragmentation of the molecular ions does not occur, and
one or more pulsed valves to change the temperature in the fragmentation zone; and
a detector for detecting at least some of the fragment ions.

14. The spectrometer of claim 13, further comprising a controller to adjust gas conditions in the fragmentation zone such that:
at a first time, at least some of the molecular ions are thermally fragmented in the fragmentation zone to form sub-molecular fragment ions using a heated gas, and
at a second time, a cooler gas is mixed with the heated gas to sufficiently reduce the gas temperature such that fragmentation of the molecular ions does not occur.

15. The spectrometer of claim 13, further comprising an ion mobility spectrometer that separates molecular ions from the ion source according to their mobility characteristics.

16. The spectrometer of claim 15, further comprising a controller to adjust gas conditions within the fragmentation zone in a pulsed manner such that only selected molecular ions are fragmented.

17. The spectrometer of claim 13, further comprising a multi-apertured plate at an entrance to the fragmentation zone to apply a voltage difference that keeps an ion residence time fixed per molecular species.

18. The spectrometer of claim 13, wherein the fragmentation zone includes an array of fragmentation channels.

19. The spectrometer of claim 18, further comprising a controller configured to control the array of fragmentation channels such that:
at a first time, fragmentation is switched on for less than all fragmentation channels in the array of fragmentation channels.

20. The spectrometer of claim 18, further comprising a controller configured to control the array of fragmentation channels such that:
at a first time, fragmentation is switched on for all fragmentation channels in the array of fragmentation channels.
